(19) United States
(12) Patent Application Publication
(10) Pub. No.: US 2020/0079910 A1
(43) Pub. Date: Mar. 12, 2020

(54) POLYORGANOSILSESQUIOXANE, TRANSFER FILM, IN-MOLD MOLDED ARTICLE, AND HARD COAT FILM

(71) Applicant: DAICEL CORPORATION, Osaka-shi, Osaka (JP)

(72) Inventors: Akihiro SHIBAMOTO, Himeji-shi (JP); Shinji MAETANI, Himeji-shi (JP); Kazuhiro NISHIDA, Himeji-shi (JP); Daisuke USA, Amagasaki-shi (JP)

(73) Assignee: DAICEL CORPORATION, Osaka-shi, Osaka (JP)

(21) Appl. No.: 16/614,007

(22) PCT Filed: May 16, 2018
(86) PCT No.: PCT/JP2018/018896

§ 371 Date: Nov. 15, 2019

(30) Foreign Application Priority Data
May 17, 2017 (JP) 2017-098511

(51) Int. Cl. C08G 77/04; C08G 59/20; B29C 45/14; B32B 27/28; B32B 7/12

(52) U.S. Cl. CPC C08G 77/045; C08G 59/20; B29C 45/14; B32B 2305/72; B32B 7/12; C08G 2120/00; B32B 2307/536; B32B 27/283

(57) ABSTRACT

An object of the present invention is to provide a polyorganosilsesquioxane that can form a hard coat layer having high surface hardness through in-mold injection molding and can form a tack-free coating film, and thus is suitable as a material for a hard coat layer of a transfer film that can be wound as a roll. The present invention relates to a polyorganosilsesquioxane having a constituent unit represented by Formula (1) below; wherein a molar ratio of a constituent unit represented by Formula (I) below to a constituent unit represented by Formula (II) below, namely [(constituent unit represented by Formula (I))/(constituent units represented by Formula (II))], is from 20 to 500; a ratio of constituent units represented by Formula (1) below and constituent units represented by Formula (4) below relative to a total amount (100 mol %) of siloxane constituent units is from 55 to 100 mol %; a number average molecular weight is from 2500 to 50000; and a molecular weight dispersity (weight average molecular weight/number average molecular weight) is from 1.0 to 4.0; and a curable composition including the polyorganosilsesquioxane.

### TECHNICAL FIELD

The present invention relates to a polyorganosilsesquioxane, a curable composition containing the polyorganosilsesquioxane, and a cured product thereof. The present invention also relates to a transfer film (particularly an in-mold injection molding transfer film) and a hard coat film, having a hard coat layer formed from a hard coat solution (hard coat agent) containing the polyorganosilsesquioxane. Furthermore, the present invention also relates to an in-mold molded article to which a transfer layer of the transfer film is transferred. The present application claims priority from JP 2017-098511 filed in Japan on May 17, 2017, the content of which is incorporated herein.

### BACKGROUND ART

An in-mold injection molding method is used as a production method for imparting a hard coating property and a decorative feature such as a wood grain texture to the surface of a plastic product. With the in-mold injection molding method, a transfer film obtained by forming a release layer on one surface of a substrate film and then laminating a transfer layer (a layer obtained by laminating a hard coat layer, an anchor coat layer, a colored layer, and an adhesive layer) on the release layer is inserted into a mold such that the substrate film side is placed in close contact with the mold inner surface, and the mold is closed, after which a melted thermoplastic resin is injected into the mold from the transfer layer side to thereby fill the mold. Subsequently, when the mold is opened and the molded product is taken out from the mold, the release layer and the hard coat layer are detached, and thus a molded article is obtained with the transfer layer transferred to the outermost surface. A UV acrylic monomer is mainly used as a material for forming the hard coat layer in such an in-mold injection molding transfer film (for example, see Patent Document 1). In order to further improve the pencil hardness of the hard coat layer surface, nanoparticles are added to the hard coat layer in some examples.

### CITATION LIST

### Patent Document

Patent Document 1: JP 2014-231221 A

### SUMMARY OF INVENTION

### Technical Problem

However, the pencil hardness of the transfer film having the hard coat layer in which the abovementioned UV acrylic monomer is used is around 2H, and thus the transfer film cannot yet be said to have sufficient surface hardness. Generally, in order to further increase the hardness, a method of making the UV acrylic monomer multifunctional or increasing the thickness of the hard coat layer is conceivable. However, in cases where such a method is used, curing shrinkage of the hard coat layer increases and results in a problem of cracks occurring in the hard coat layer. Furthermore, when nanoparticles are added to the hard coat layer, the nanoparticles aggregate when compatibility between the nanoparticles and the UV acrylic monomer is poor, and this results in a problem of whitening of the hard coat layer.

In addition, after a hard coat solution or the like is coated to the release layer of the substrate film and dried, the surface of the uncured or semi-cured hard coat layer needs to be tack-free. This is because if the surface is tacky, blocking resistance declines, and winding into a roll becomes difficult.

Therefore, an object of the present invention is to provide a polyorganosilsesquioxane that can form a hard coat layer having high surface hardness through an in-mold injection molding method, can form a tack-free coating film at an uncured or semi-cured stage, and is suitable as a material for a hard coat layer of a transfer film that can be wound as a roll.

Another object of the present invention is to provide a transfer film that can form a hard coat layer having high surface hardness through an in-mold injection molding method, can form a tack-free coating film at an uncured or semi-cured stage, and can be wound as a roll.

Yet another object of the present invention is to provide an in-mold molded article to which a transfer layer of the transfer film is transferred and which has high surface hardness.

Applications in which transfer films having a hard coat layer are used have increased in recent years, and the hard coat layer having the transfer film is particularly required to exhibit excellent heat resistance in addition to having high surface hardness as described above. The hard coat layer of the transfer film that uses the UV acrylic monomer described above cannot be said to be sufficient from the perspective of such heat resistance.

Furthermore, a hard coat film having a hard coat layer is generally required to also have high flexibility and processability in addition to high surface hardness. This is because, when flexibility and processability are poor, production and processing with a roll-to-roll process cannot be performed, and thus production costs are high.

### Solution to Problem

The inventors of the present invention discovered that when a polyorganosilsesquioxane that has a silsesquioxane constituent unit (unit structure) containing a polymerizable functional group, has a ratio of specific structures (ratio of T3 forms and T2 forms, ratio of silsesquioxane constituent units containing a polymerizable functional group) that is controlled to a specific range, has a high number average molecular weight, and has a molecular weight dispersity that is controlled to a specific range, is used, a surface of an uncured or semi-cured hard coat layer containing the polyorganosilsesquioxane is tack-free, thereby enabling winding and handling in a roll shape, and when in-mold injection molding is performed using a transfer film having the hard coat layer, a molded article coated with a hard coat layer having a high surface hardness can be produced. The present invention was completed based on these findings.

Namely, the present invention provides a polyorganosilsesquioxane containing a constituent unit represented by Formula (1) below:

[Chem. 1]

[R¹SiO_{3/2}] (1)

[where R¹ represents a group containing a polymerizable functional group];

a constituent unit expressed by Formula (I) below:

[Chem. 2]

[R^{a}SiO_{3/2}] (I)

[where R^{a} represents a group containing a polymerizable functional group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom];

a constituent unit represented by Formula (II) below:

[Chem. 3]

[R^{b}SiO_{2/2}(OR^{c})] (II)

[where R^{b} represents a group containing a polymerizable functional group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom; and R^{c} represents a hydrogen atom or an alkyl group having from 1 to 4 carbon atoms]; and

a constituent unit expressed by Formula (4) below:

[Chem. 4]

[R¹SiO_{2/2}(OR^{c})] (4)

[where R¹ is the same as in Formula (1), and R^{c} is the same as in Formula (II)]; wherein

a molar ratio of the constituent unit represented by Formula (I) to the constituent unit represented by Formula (II), [(the constituent unit represented by Formula (I))/(the constituent unit represented by Formula (II))], is from 20 to 500,

a proportion of the constituent unit represented by Formula (1) and the constituent unit represented by Formula (4) is from 55 to 100 mol % relative to a total amount (100 mol %) of siloxane constituent units,

a number average molecular weight is from 2500 to 50000, and

a molecular weight dispersity (weight average molecular weight/number average molecular weight) is from 1.0 to 4.0.

The abovementioned polyorganosilsesquioxane may further contain a constituent unit expressed by Formula (2) below:

[Chem. 5]

[R²SiO_{3/2}] (2)

where R² represents a substituted or unsubstituted aryl group, a substituted or unsubstituted aralkyl group, a substituted or unsubstituted cycloalkyl group, a substituted or unsubstituted alkyl group, or a substituted or unsubstituted alkenyl group.

In the polyorganosilsesquioxane, the R² may be a substituted or unsubstituted aryl group.

In the polyorganosilsesquioxane, the polymerizable functional group may be an epoxy group.

In the polyorganosilsesquioxane, the R¹ may be:

a group represented by Formula (1a) below;

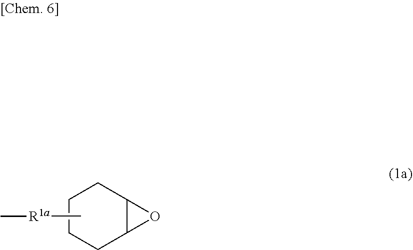

where R^{1a} represents a linear or branched alkylene group;

a group represented by Formula (1b) below,

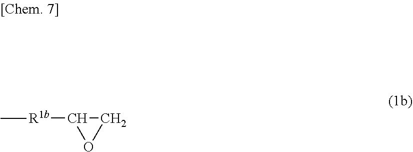

where R^{1b} represents a linear or branched alkylene group;

a group represented by the Formula (1c) below:

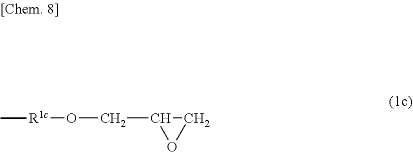

where R^{1c} represents a linear or branched alkylene group; or

a group represented by Formula (1d) below:

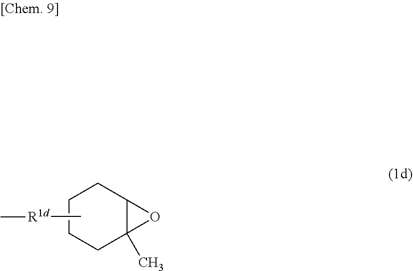

where R^{1d} represents a linear or branched alkylene group.

The present invention also provides a curable composition containing a polyorganosilsesquioxane.

The curable composition may further contain a curing catalyst.

In the curable composition, the curing catalyst may be a photocationic polymerization initiator.

In the curable composition, the curing catalyst may be a thermal cationic polymerization initiator.

In the curable composition, the curing catalyst may be a photoradical polymerization initiator.

In the curable composition, the curing catalyst may be a thermal radical polymerization initiator.

The curable composition may further contain a vinyl ether compound.

The curable composition may further contain a vinyl ether compound having a hydroxyl group in the molecule.

The curable composition may be a curable composition for forming a hard coat layer.

In addition, the present invention provides a cured product of the curable composition.

The present invention also provides a transfer film containing a substrate, and a hard coat layer laminated on a release layer formed on at least one surface of the substrate, wherein the hard coat layer contains the abovementioned curable composition for forming a hard coat layer.

In the transfer film, an anchor coat layer and an adhesive agent layer may be further laminated in this order on the hard coat layer.

The transfer film may further include at least one colored layer.

In the transfer film, the thickness of the hard coat layer may be from 3 to 150 μm.

The transfer film may be a transfer film that is used for in-mold injection molding.

In addition, the present invention provides an in-mold molded article to which a layer (transfer layer) is transferred, wherein the layer (the transfer layer) is obtained by removing the substrate on which the release layer is formed from the transfer film.

The present invention also provides a hard coat film including a substrate and a hard coat layer formed on at least one surface of the substrate, wherein the hard coat layer is a cured product layer of the curable composition for forming a hard coat layer.

In the hard coat film, the thickness of the hard coat layer may be from 1 to 200 μm.

The hard coat film may be producible with a roll-to-roll process.

The hard coat film may have a surface protection film on the surface of the hard coat layer.

The present invention also provides a method for producing a hard coat film, the method including: (A) feeding out a substrate wound in a roll shape; (B) coating the curable composition for forming a hard coat layer to at least one surface of the substrate that was fed out, and then curing the curable composition to form a hard coat layer; and subsequently, (C) winding the obtained hard coat film onto a roll once again; wherein the steps (A) to (C) are performed sequentially.

### Advantageous Effects of Invention

Since the polyorganosilsesquioxane of the present invention has the above configuration, a molded article coated with a hard coat layer having a high surface hardness can be produced by performing in-mold injection molding using a transfer film having a hard coat layer that contains the polyorganosilsesquioxane as an essential component. Furthermore, an uncured or semi-cured hard coat layer containing the polyorganosilsesquioxane of the present invention is tack-free and can be wound and handled in a roll form, and a transfer film containing the hard coat layer can be handled in a roll-to-roll manner, and therefore can be suitably used for in-mold injection molding. Thus, the transfer film of the present invention excels in both quality and cost.

### BRIEF DESCRIPTION OF DRAWINGS

FIG. 1 is a ¹H-NMR chart of an intermediate epoxy group-containing polyorganosilsesquioxane obtained in Production Example 1.

FIG. 2 is a ²⁹Si-NMR chart of the intermediate epoxy group-containing polyorganosilsesquioxane obtained in Production Example 1.

FIG. 3 is a ¹H-NMR chart of an epoxy group-containing polyorganosilsesquioxane according to an embodiment of the present invention obtained in Example 1.

FIG. 4 is a ²⁹Si-NMR chart of the epoxy group-containing polyorganosilsesquioxane according to an embodiment of the present invention obtained in Example 1.

FIG. 5 is a ¹H-NMR chart of an epoxy group-containing polyorganosilsesquioxane according to an embodiment of the present invention obtained in Example 3.

FIG. 6 is a ²⁹Si-NMR chart of the epoxy group-containing polyorganosilsesquioxane according to an embodiment of the present invention obtained in Example 3.

FIG. 7 is a ¹H-NMR chart of an intermediate acrylic group-containing polyorganosilsesquioxane obtained in Production Example 2.

FIG. 8 is a ²⁹Si-NMR chart of the intermediate acrylic group-containing polyorganosilsesquioxane obtained in Production Example 2.

FIG. 9 is a ¹H-NMR chart of an acrylic group-containing polyorganosilsesquioxane according to an embodiment of the present invention obtained in Example 4.

FIG. 10 is a ²⁹Si-NMR chart of the acrylic group-containing polyorganosilsesquioxane according to an embodiment of the present invention obtained in Example 4.

### DESCRIPTION OF EMBODIMENTS

### Polyorganosilsesquioxane

The polyorganosilsesquioxane (silsesquioxane) according to an embodiment of the present invention includes a constituent unit represented by Formula (1) below; wherein a molar ratio of constituent units represented by Formula (I) below (may be referred to as “T3 forms”) to constituent units represented by Formula (II) below (may be referred to as “T2 forms”), namely the molar ratio of [(constituent units represented by Formula (I))/(constituent units represented by Formula (II))] (may be described as “T3 forms/T2 forms”), is from 20 to 500; a ratio (total amount) of constituent units represented by Formula (1) below and constituent units represented by Formula (4) described later relative to a total amount (100 mol %) of siloxane constituent units is from 55 to 100 mol %; a number average molecular weight is from 2500 to 50000; and a molecular weight dispersity [weight average molecular weight/number average molecular weight] is from 1.0 to 4.0:

[Chem. 10]

[R¹SiO_{3/2}] (1)

[Chem. 11]

[R^{a}SiO_{3/2}] (I)

[Chem. 12]

[R^{b}SiO_{2/2}(OR^{c})] (II)

The constituent unit represented by Formula (1) above is a silsesquioxane constituent unit (so-called T unit) generally represented by [RSiO_{3/2}]. Here, R in the above formula represents a hydrogen atom or a monovalent organic group and is also the same below. The constituent unit represented by Formula (1) above is formed by hydrolysis and condensation reaction of a corresponding hydrolyzable trifunctional silane compound (specifically, a compound represented by Formula (a) described later, for example).

R¹ in Formula (1) represents a group (monovalent group) containing a polymerizable functional group. That is, the polyorganosilsesquioxane according to an embodiment of the present invention is a cationically curable compound (compound having a cationically polymerizable functional group) or a radically curable compound (compound having a radically polymerizable functional group), having at least a polymerizable functional group in the molecule.

The “cationically polymerizable functional group” in the group containing a polymerizable functional group is not particularly limited as long as it has cationic polymerizability, and examples thereof include an epoxy group, an oxetane group, a vinyl ether group, and a vinyl phenyl group.

The “radically polymerizable functional group” in the group containing a polymerizable functional group is not particularly limited as long as it has radical polymerizability, and examples thereof include a (meth) acryloxy group, a (meth) acrylamide group, a vinyl group, and a vinylthio group.

From the perspective of surface hardness (for example, 4H or greater) of the cured product, the polymerizable functional group is preferably an epoxy group, a (meth) acryloxy group, or the like, and an epoxy group is particularly preferable.

The group containing a polymerizable functional group is not particularly limited, and examples include well-known or commonly used groups having a polymerizable functional group. However, in terms of curability of the curable composition, and surface hardness and heat resistance of the cured product, a group represented by Formula (1a) below, a group represented by Formula (1b) below, a group represented by Formula (1c) below, and a group represented by Formula (1d) below are preferable, a group represented by Formula (1a) below and a group represented by Formula (1c) below are more preferable, and a group represented by Formula (1a) below is even more preferable.

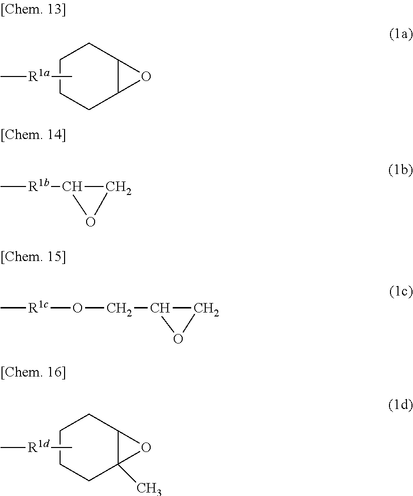

In Formula (1a) above, R^{1a} represents a linear or branched alkylene group. Examples of the linear or branched alkylene group include linear or branched alkylene groups having from 1 to 10 carbon atoms, such as a methylene group, a methyl methylene group, a dimethyl methylene group, an ethylene group, a propylene group, a trimethylene group, a tetramethylene group, a pentamethylene group, a hexamethylene group, and a decamethylene group. Among these, in terms of surface hardness and curability of the cured product, R^{1a} is preferably a linear alkylene group having from 1 to 4 carbon atoms or a branched alkylene group having 3 or 4 carbon atoms, more preferably an ethylene group, a trimethylene group, or a propylene group, and even more preferably an ethylene group or a trimethylene group.

In Formula (1b) above, R^{1b} represents a linear or branched alkylene group, and the same groups as those of R^{1a} are exemplified. Among these, in terms of surface hardness and curability of the cured product, R^{1b} is preferably a linear alkylene group having from 1 to 4 carbon atoms or a branched alkylene group having 3 or 4 carbon atoms, more preferably an ethylene group, a trimethylene group, or a propylene group, and even more preferably an ethylene group or a trimethylene group.

In Formula (1c) above, R^{1c} represents a linear or branched alkylene group, and the same groups as those of R^{1a} are exemplified. Among these, in terms of surface hardness and curability of the cured product, R^{1c} is preferably a linear alkylene group having from 1 to 4 carbon atoms or a branched alkylene group having 3 or 4 carbon atoms, more preferably an ethylene group, a trimethylene group, or a propylene group, and even more preferably an ethylene group or a trimethylene group.

In Formula (1d) above, R^{1d} represents a linear or branched alkylene group, and the same groups as those of R^{1a} are exemplified. Among these, in terms of surface hardness and curability of the cured product, R^{1d} is preferably a linear alkylene group having from 1 to 4 carbon atoms or a branched alkylene group having 3 or 4 carbon atoms, more preferably an ethylene group, a trimethylene group, or a propylene group, and even more preferably an ethylene group or a trimethylene group.

R¹ in Formula (1) is particularly preferably a group represented by Formula (1a) above, in which R^{1a} is an ethylene group (among which a 2-(3′,4′-epoxycyclohexyl)ethyl group is preferred).

The group containing an oxetane group is not particularly limited, and examples include known or commonly used groups having an oxetane ring, including, for example, oxetane groups themselves, and groups obtained by replacing a hydrogen atom (ordinarily one or more, preferably one hydrogen atom) of an alkyl group (alkyl group having preferably from 1 to 10 carbon atoms, and more preferably from 1 to 5 carbon atoms) with an oxetane group. From the perspectives of curability of the curable composition and heat resistance of the cured product, a 3-oxetanyl group, an oxetan-3-yl methyl group, a 3-ethyloxetan-3-yl methyl group, a 2-(oxetan-3-yl) ethyl group, a 2-(3-ethyloxetan-3-yl) ethyl group, a 3-(oxetan-3-yl methoxy) propyl group, and a 3-(3-ethyloxetan-3-yl methoxy) propyl group are preferable.

The group containing a vinyl ether group is not particularly limited, and examples include well-known or commonly used groups having a vinyl ether group, including, for example, vinyl ether groups themselves; and groups obtained by replacing a hydrogen atom (ordinarily one or more, preferably one hydrogen atom) of an alkyl group (alkyl group having preferably from 1 to 10 carbon atoms, and more preferably from 1 to 5 carbon atoms) with a vinyl ether group. From the perspectives of curability of the curable composition and heat resistance of the cured product, a vinyloxy methyl group, a 2-(vinyloxy) ethyl group, and a 3-(vinyloxy) propyl group are preferable.

The group containing a vinyl phenyl group is not particularly limited, and examples include well-known or commonly used groups having a vinyl phenyl group, including, for example, vinyl phenyl groups themselves; and groups obtained by replacing a hydrogen atom (ordinarily one or more, preferably one hydrogen atom) of an alkyl group (alkyl group having preferably from 1 to 10 carbon atoms, and more preferably from 1 to 5 carbon atoms) with a vinyl phenyl group. From the perspectives of curability of the curable composition and heat resistance of the cured product, a 4-vinylphenyl group, a 3-vinylphenyl group, a 2-vinylphenyl group, and the like, are preferable.

The group containing a (meth)acryloxy group is not particularly limited, and examples include well-known or commonly used groups having a (meth)acryloxy group, including, for example, (meth)acryloxy groups themselves; and groups obtained by replacing a hydrogen atom (ordinarily one or more, preferably one hydrogen atom) of an alkyl group (alkyl group having preferably from 1 to 10 carbon atoms, and more preferably from 1 to 5 carbon atoms) with a (meth)acryloxy group. From the perspectives of curability of the curable composition and heat resistance of the cured product, a 2-((meth)acryloxy)ethyl group, and a 3-((meth)acryloxy)propyl group are preferable.

The group containing a (meth)acrylamide group is not particularly limited, and examples include well-known or commonly used groups having a (meth)acrylamide group, including, for example, (meth)acrylamide groups themselves; and groups obtained by replacing a hydrogen atom (ordinarily one or more, preferably one hydrogen atom) of an alkyl group (alkyl group having preferably from 1 to 10 carbon atoms, and more preferably from 1 to 5 carbon atoms) with a (meth)acrylamide group. From the perspectives of curability of the curable composition and heat resistance of the cured product, a 2-((meth)acrylamide) ethyl group, and a 3-((meth)acrylamide) propyl group are preferable.

The group containing a vinyl group is not particularly limited, and examples include well-known or commonly used groups having a vinyl group, including, for example, vinyl groups themselves; and groups obtained by replacing a hydrogen atom (ordinarily one or more, preferably one hydrogen atom) of an alkyl group (alkyl group having preferably from 1 to 10 carbon atoms, and more preferably from 1 to 5 carbon atoms) with a vinyl group. From the perspectives of curability of the curable composition and heat resistance of the cured product, a vinyl group, a vinylmethyl group, a 2-vinylethyl group, and a 3-vinylpropyl group are preferable.

The group containing a vinylthio group is not particularly limited, and examples include well-known or commonly used groups having a vinylthio group, including, for example, vinylthio groups themselves; and groups obtained by replacing a hydrogen atom (ordinarily one or more, preferably one hydrogen atom) of an alkyl group (alkyl group having preferably from 1 to 10 carbon atoms, and more preferably from 1 to 5 carbon atoms) with a vinylthio group. From the perspectives of curability of the curable composition and heat resistance of the cured product, a vinylthiomethyl group, a 2-(vinylthio)ethyl group, and a 3-(vinylthio)propyl group are preferable.

R¹ in Formula (1) is preferably a group containing an epoxy group, or a group containing a (meth)acryloxy group, and is particularly preferably a group represented by Formula (1a) above in which R^{1a} is an ethylene group (among which a 2-(3′,4′-epoxycyclohexyl)ethyl group is preferable); a 3-(acryloxy)propyl group, or a 3-(methacryloxy)propyl group.

The polyorganosilsesquioxane according to an embodiment of the present invention may include only one type of constituent unit represented by Formula (1) above or may include two or more types of constituent units represented by Formula (1) above.

The polyorganosilsesquioxane according to an embodiment of the present invention may also include, as a silsesquioxane constituent unit [RSiO_{3/2}], a constituent unit represented by Formula (2) below, in addition to the constituent unit represented by Formula (1) above.

[Chem. 17]

[R²SiO_{3/2}] (2)

The constituent unit represented by Formula (2) above is a silsesquioxane constituent unit (T unit) generally represented by [RSiO_{3/2}]. That is, the constituent unit represented by Formula (2) above is formed by a hydrolysis and condensation reaction of a corresponding hydrolyzable trifunctional silane compound (specifically, for example, a compound represented by Formula (b) described later).

R² in Formula (2) represents a substituted or unsubstituted aryl group, a substituted or unsubstituted aralkyl group, a substituted or unsubstituted cycloalkyl group, a substituted or unsubstituted alkyl group, or a substituted or unsubstituted alkenyl group. Examples of the aryl group include a phenyl group, a tolyl group, and a naphthyl group. Examples of the aralkyl group include a benzyl group and a phenethyl group. Examples of the cycloalkyl group include a cyclobutyl group, a cyclopentyl group, and a cyclohexyl group. Examples of the alkyl group include linear or branched alkyl groups, such as a methyl group, an ethyl group, a propyl group, an n-butyl group, an isopropyl group, an isobutyl group, an s-butyl group, a t-butyl group, and an isopentyl group. Examples of the alkenyl group include linear or branched alkenyl groups, such as a vinyl group, an allyl group, and an isopropenyl group.

Examples of the substituted aryl group, the substituted aralkyl group, the substituted cycloalkyl group, the substituted alkyl group, and the substituted alkenyl group described above include a group in which some or all of hydrogen atoms or a portion or the entirety of the backbone in each of the aryl group, the aralkyl group, the cycloalkyl group, the alkyl group, and the alkenyl group described above are substituted with at least one type selected from the group consisting of an ether group, an ester group, a carbonyl group, a siloxane group, a halogen atom (such as a fluorine atom), an acrylic group, a methacrylic group, a mercapto group, an amino group, and a hydroxy group (hydroxyl group).

Among these, R² is preferably a substituted or unsubstituted aryl group, a substituted or unsubstituted alkyl group, or a substituted or unsubstituted alkenyl group, more preferably a substituted or unsubstituted aryl group, and even more preferably a phenyl group.

A ratio of each silsesquioxane constituent unit described above (the constituent unit represented by Formula (1) and the constituent unit represented by Formula (2)) in the polyorganosilsesquioxane according to an embodiment of the present invention can be appropriately adjusted by the composition of the raw materials (hydrolyzable trifunctional silanes) for forming these constituent units.

The polyorganosilsesquioxane according to an embodiment of the present invention may further include, in addition to the constituent unit represented by Formula (1) above and the constituent unit represented by Formula (2) above, at least one type of siloxane constituent unit selected from the group consisting of a silsesquioxane constituent unit [RSiO_{3/2}] other than the constituent unit represented by Formula (1) above and the constituent unit represented by Formula (2) above; a constituent unit represented by [R₃SiO_{1/2}](“M unit”); a constituent unit represented by [R₂SiO_{2/2}] (“D unit”); and a constituent unit represented by [SiO_{4/2}] (“Q unit”). Here, examples of the silsesquioxane constituent unit other than the constituent unit represented by Formula (1) above and the constituent unit represented by Formula (2) above include a constituent unit represented by Formula (3) below.

[Chem. 18]

[HSiO_{3/2}] (3)

A [T3 forms/T2 forms] ratio of the constituent unit (T3 form) represented by Formula (I) above to the constituent unit (T2 form) represented by Formula (II) above in the polyorganosilsesquioxane according to an embodiment of the present invention is, as described above, from 20 to 500. The lower limit of the abovementioned [T3 forms/T2 forms] ratio is preferably 21, more preferably 23, and even more preferably 25. By setting the abovementioned [T3 forms/T2 forms] ratio to 20 or greater, the surface, when the uncured or semi-cured hard coat layer is formed, is easily made tack-free, blocking resistance is improved, winding onto a roll is facilitated, the polyorganosilsesquioxane can be preferably used as a component of the hard coat layer of a transfer film for in-mold injection molding, and the surface hardness and adhesion of the cured product and hard coat layer are significantly improved. On the other hand, the upper limit value of the abovementioned [T3 forms/T2 forms] ratio is preferably 100, more preferably 50, and even more preferably 40. By setting the abovementioned [T3 forms/T2 forms] ratio to 500 or less, miscibility with other components in the curable composition is improved, and the increase in viscosity is suppressed, and therefore handling is simplified, and coating as a hard coat layer is facilitated.

The constituent unit represented by Formula (I) above is represented by Formula (I′) below when described in more detail. Furthermore, the constituent unit represented by Formula (II) above is represented by Formula (II′) below when described in greater detail. Three oxygen atoms bonded to the silicon atom illustrated in the structure represented by Formula (I′) below are each bonded to another silicon atom (a silicon atom not illustrated in Formula (I′)). On the other hand, two oxygen atoms located above and below the silicon atom illustrated in the structure represented by Formula (II′) below are each bonded to another silicon atom (a silicon atom not illustrated in Formula (II′)). That is, both the T3 form and the T2 form are constituent units (T units) formed by a hydrolysis and condensation reaction of a corresponding hydrolyzable trifunctional silane compound.

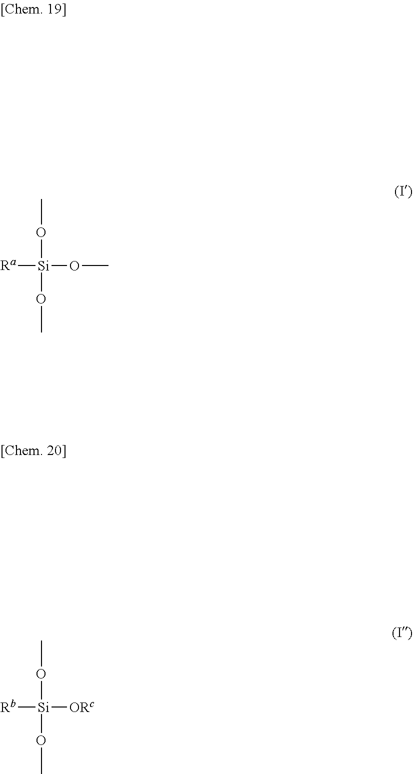

R^{a} in Formula (I) above (likewise, R^{a} in Formula (I′)) and R^{b} in Formula (II) above (likewise, R^{b} in Formula (II′)) each represent a group containing a polymerizable functional group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom. Specific examples of R^{a} and R^{b} include the same examples as those given for R¹ in Formula (1) above and R² in Formula (2) above. R^{a} in Formula (I) and R^{b} in Formula (II) are each derived from a group (a group other than an alkoxy group and a halogen atom; for example, R¹, R², and a hydrogen atom, etc. in Formulae (a) to (c) described later) bonded to a silicon atom in the hydrolyzable trifunctional silane compound used as a raw material for the polyorganosilsesquioxane according to an embodiment of the present invention.

R^{c} in Formula (II) above (likewise, R^{c} in Formula (II′)) represents a hydrogen atom or an alkyl group having from 1 to 4 carbon atoms. Examples of the alkyl group having from 1 to 4 carbons include linear or branched alkyl groups having from 1 to 4 carbons, such as a methyl group, an ethyl group, a propyl group, an isopropyl group, a butyl group, and an isobutyl group. The alkyl group in R^{c} in Formula (II) is typically derived from an alkyl group that forms an alkoxy group (for example, an alkoxy group as X¹ to X³ described later) in the hydrolyzable silane compound used as a raw material for the polyorganosilsesquioxane according to an embodiment of the present invention.

The above [T3 forms/T2 forms] ratio in the polyorganosilsesquioxane according to an embodiment of the present invention can be determined, for example, by ²⁹Si-NMR spectrum measurements. In the ²⁹Si-NMR spectrum, the silicon atom in the constituent unit represented by Formula (I) above (T3 form) and the silicon atom in the constituent unit represented by Formula (II) above (T2 form) exhibit signals (peaks) at different positions (chemical shifts), and thus the ratio [T3 forms/T2 forms] above is determined by calculating the integration ratio of these respective peaks. Specifically, for example, when the polyorganosilsesquioxane according to an embodiment of the present invention includes a constituent unit represented by Formula (1) above wherein R¹ is a 2-(3′,4′-epoxycyclohexyl)ethyl group, the signal of the silicon atom in the structure represented by Formula (I) above (T3 form) appears at −64 to −70 ppm, and the signal of the silicon atom in the structure represented by Formula (II) above (T2 form) appears at −54 to −60 ppm. Thus, in this case, the above ratio [T3 form/T2 form] can be determined by calculating the integration ratio of the signal at −64 to −70 ppm (T3 form) and the signal at −54 to −60 ppm (T2 form). For a case in which R¹ is a group that includes a polymerizable functional group other than the 2-(3′,4′-epoxycyclohexyl) ethyl group, the [T3 forms/T2 forms] ratio can be determined in the same manner.

The ²⁹Si-NMR spectrum of the polyorganosilsesquioxane according to an embodiment of the present invention can be measured, for example, with the following instrument and conditions.

Measuring instrument: “JNM-ECA500NMR” (trade name, available from JEOL Ltd.)

Solvent: Deuteriochloroform

Cumulative number of scans: 1800 scans

Measurement temperature: 25° C.

When the above [T3 forms/T2 forms] ratio of the polyorganosilsesquioxane according to an embodiment of the present invention is not less than 20 and not greater than 500, the presence amount of T2 forms relative to T3 forms in the polyorganosilsesquioxane according to an embodiment of the present invention is relatively small, and the hydrolysis and condensation reaction of silanol have advanced considerably. Examples of such a T2 form include a constituent unit represented by Formula (4) below, a constituent unit represented by Formula (5) below, and a constituent unit represented by Formula (6) below. R¹ in Formula (4) below and R² in Formula (5) below are the same as the R¹ in Formula (1) above and the R² in Formula (2) above, respectively. R^{c} in Formulas (4) to (6) below represents a hydrogen atom or an alkyl group having from 1 to 4 carbon atoms, similar to R^{c} in Formula (II).

[Chem. 21]

[R¹SiO_{2/2}(OR^{c})] (4)

[Chem. 22]

[R²SiO_{2/2}(OR^{c})] (5)

[Chem. 23]

[HSiO_{2/2}(OR^{c})] (6)

The polyorganosilsesquioxane according to an embodiment of the present invention may have any of a cage-type, an incomplete cage-type, a ladder-type, or a random-type silsesquioxane structure, or may have a combination of two or more of these silsesquioxane structures.

The ratio (total amount) of the constituent units represented by Formula (1) above and the constituent units represented by Formula (4) above relative to a total amount (100 mol %) of siloxane constituent units [all siloxane constituent units; total amount of M units, D units, T units, and Q units] in the polyorganosilsesquioxane according to an embodiment of the present invention is, as described above, from 55 to 100 mol %, preferably from 65 to 100 mol %, and more preferably from 80 to 99 mol %. When the above ratio is set to 55 mol % or greater, the curability of the curable composition improves, and the surface hardness and adhesion of the cured product significantly increase. In addition, the ratio of each siloxane constituent unit in the polyorganosilsesquioxane according to an embodiment of the present invention can be calculated, for example, from the composition of the raw materials and NMR spectrum measurements.

The ratio (total amount) of the constituent units represented by Formula (2) above and the constituent units represented by Formula (5) above relative to a total amount (100 mol %) of siloxane constituent units [all siloxane constituent units; total amount of M units, D units, T units, and Q units] in the polyorganosilsesquioxane according to an embodiment of the present invention is not particularly limited, but is preferably from 0 to 70 mol %, more preferably from 0 to 60 mol %, even more preferably from 0 to 40 mol %, and particularly preferably from 1 to 15 mol %. When the above ratio is set to 70 mol % or less, the ratio of the constituent units represented by Formula (1) and the constituent units represented by Formula (4) can be relatively increased, and thus such a ratio tends to improve the curability of the curable composition and further increase the surface hardness and adhesion of the resulting cured product. On the other hand, setting the above ratio to 1 mol % or greater tends to improve gas barrier properties of the resulting cured product.

The ratio (total amount) of the constituent units represented by Formula (1) above, the constituent units represented by Formula (2) above, the constituent units represented by Formula (4) above, and the constituent units represented by Formula (5) above relative to a total amount (100 mol %) of siloxane constituent units [all siloxane constituent units; total amount of M units, D units, T units, and Q units] in the polyorganosilsesquioxane according to an embodiment of the present invention is not particularly limited, but is preferably from 60 to 100 mol %, more preferably from 70 to 100 mol %, and even more preferably from 80 to 100 mol %. Setting the above ratio to 60 mol % or greater tends to further increase the surface hardness and adhesion of the resulting cured product.

The number average molecular weight (Mn) of the polyorganosilsesquioxane according to an embodiment of the present invention determined by gel permeation chromatography, calibrated with standard polystyrene, is, as described above, from 2500 to 50000, preferably from 2800 to 10000, and more preferably from 3000 to 8000. By setting the number average molecular weight to 2500 or greater, the surface when formed as an uncured or semi-cured hard coat layer tends to be tack-free, blocking resistance is improved, winding onto a roll is facilitated, the polyorganosilsesquioxane can be preferably used as a component of the hard coat layer of a transfer film for in-mold injection molding, and the heat resistance, scratch resistance, and adhesion of the cured product are further improved. On the other hand, setting the number-average molecular weight to 50000 or less improves the compatibility with other components in the curable composition, and further improves the heat resistance of the resulting cured product.

The molecular weight dispersity (Mw/Mn) of the polyorganosilsesquioxane according to an embodiment of the present invention determined by gel permeation chromatography, calibrated with standard polystyrene, is, as described above, from 1.0 to 4.0, preferably from 1.1 to 3.0, and more preferably from 1.2 to 2.5. When the molecular weight dispersity is set to 4.0 or less, the surface hardness and adhesion of the resulting cured product are further increased. On the other hand, when the molecular weight dispersity is set to 1.1 or greater, the polyorganosilsesquioxane tends to easily become liquid, and handling ease tends to improve.

The number average molecular weight and the molecular weight dispersity of the polyorganosilsesquioxane according to an embodiment of the present invention can be measured with the following instruments and conditions.

Measuring instrument: “LC-20AD” (trade name, available from Shimadzu Corporation)

Column: Shodex KF-801×quantity of 2, KF-802, and KF-803 (available from Showa Denko K.K.)

Measurement temperature: 40° C.

Eluent: THF, sample concentration of 0.1 to 0.2 wt. %

Flow rate: 1 mL/min

Detector: UV-VIS detector (trade name “SPD-20A”, available from Shimadzu Corporation)

Molecular weight: calibrated with standard polystyrene

A 5% weight loss temperature (T_{d5}) of the polyorganosilsesquioxane according to an embodiment of the present invention in an air atmosphere is not particularly limited, and is preferably 330° C. or higher (for example, from 330 to 450° C.), more preferably 340° C. or higher, and even more preferably 350° C. or higher. The polyorganosilsesquioxane with a 5% weight loss temperature of 330° C. or higher tends to further improve the heat resistance of the cured product. In particular, when the polyorganosilsesquioxane is configured such that the above [T3 forms/T2 forms] ratio is from 20 to 500, the number average molecular weight is from 2500 to 5000, and the molecular weight dispersity is from 1.0 to 4.0, the 5% weight loss temperature thereof is controlled to be 330° C. or higher. Here, the 5% weight loss temperature is the temperature at which the weight decreases by 5% compared to the weight prior to heating when heated at a constant temperature increase rate, and is an indicator of heat resistance. The 5% weight loss temperature can be measured by thermogravimetric analysis (TGA) under conditions of a temperature increase rate of 5° C./min in air atmosphere.

The method for producing the polyorganosilsesquioxane according to an embodiment of the present invention is not particularly limited, and the polyorganosilsesquioxane can be produced by a well-known or commonly used polysiloxane production method. Examples include a method of subjecting one or more types of hydrolyzable silane compounds to hydrolysis and condensation. As the hydrolyzable silane compound, however, a hydrolyzable trifunctional silane compound (compound represented by Formula (a) below) for forming the constituent unit represented by the Formula (1) described above needs to be used as an essential hydrolyzable silane compound.

More specifically, for example, the polyorganosilsesquioxane according to an embodiment of the present invention can be produced by a method of hydrolysis and condensation of a compound represented by Formula (a) below, which is a hydrolyzable silane compound for forming a silsesquioxane constituent unit (T unit) in the polyorganosilsesquioxane according to an embodiment of the present invention, and additionally as necessary, a compound represented by Formula (b) below and a compound represented by Formula (c) below.

[Chem. 24]

R¹Si(X¹)₃ (a)

[Chem. 25]

R²Si(X²)₃ (b)

[Chem. 26]

HSi(X³)₃ (c)

The compound represented by Formula (a) above is a compound that forms a constituent unit represented by Formula (1) in the polyorganosilsesquioxane according to an embodiment of the present invention. R¹ in Formula (a) represents a group containing an polymerizable functional group, as in the case of R¹ in Formula (1) above. That is, R¹ in Formula (a) is preferably a group represented by Formula (1a) above, a group represented by Formula (1b) above, a group represented by Formula (1c) above, or a group represented by Formula (1d) above, more preferably a group represented by Formula (1a) above or a group represented by Formula (1c) above, even more preferably a group represented by Formula (1a) above, and particularly preferably a group represented by Formula (1a) above wherein R^{1a} is an ethylene group (in particular, a 2-(3′,4′-epoxycyclohexyl)ethyl group).

X¹ in Formula (a) above represents an alkoxy group or a halogen atom. Examples of the alkoxy group in X¹ include alkoxy groups having from 1 to 4 carbons, such as a methoxy group, an ethoxy group, a propoxy group, an isopropyloxy group, a butoxy group, and an isobutyloxy group. In addition, examples of the halogen atom in X¹ include a fluorine atom, a chlorine atom, a bromine atom, and an iodine atom. Among these, X¹ is preferably an alkoxy group, and more preferably a methoxy group and an ethoxy group. In addition, each of the three X¹ may be the same or different.

The compound represented by Formula (b) above is a compound that forms a constituent unit represented by Formula (2) in the polyorganosilsesquioxane according to an embodiment of the present invention. R² in Formula (b) represents, as in the case of R² in Formula (2) above, a substituted or unsubstituted aryl group, a substituted or unsubstituted aralkyl group, a substituted or unsubstituted cycloalkyl group, a substituted or unsubstituted alkyl group, or a substituted or unsubstituted alkenyl group. That is, R² in Formula (b) is preferably a substituted or unsubstituted aryl group, a substituted or unsubstituted alkyl group, or a substituted or unsubstituted alkenyl group, more preferably a substituted or unsubstituted aryl group, and even more preferably a phenyl group.

X² in Formula (b) above represents an alkoxy group or a halogen atom. Specific examples of X² include those exemplified as X¹. Among these, X² is preferably an alkoxy group, and more preferably a methoxy group or an ethoxy group. In addition, each of the three X² may be the same or different.

The compound represented by Formula (c) above is a compound that forms a constituent unit represented by Formula (3) in the polyorganosilsesquioxane according to an embodiment of the present invention. X³ in Formula (c) above represents an alkoxy group or a halogen atom. Specific examples of X³ include those exemplified as X¹. Among these, X³ is preferably an alkoxy group, and more preferably a methoxy group and an ethoxy group. In addition, each of the three X³ each may be the same or different.

A hydrolyzable silane compound other than the compounds represented by Formulae (a) to (c) above may be used in combination as the hydrolyzable silane compound. Examples thereof include hydrolyzable trifunctional silane compounds other than the compounds represented by Formulae (a) to (c) above, hydrolyzable monofunctional silane compounds forming an M unit, hydrolyzable bifunctional silane compounds forming a D unit, and hydrolyzable tetrafunctional silane compounds forming a Q unit.

The usage amount and the composition of the hydrolyzable silane compound can be appropriately adjusted according to the desired structure of the polyorganosilsesquioxane according to an embodiment of the present invention. For example, the usage amount of the compound represented by Formula (a) above is not particularly limited but is preferably from 55 to 100 mol %, more preferably from 65 to 100 mol %, and even more preferably from 80 to 99 mol %, relative to a total amount (100 mol %) of the hydrolyzable silane compound that is used.

In addition, the usage amount of the compound represented by Formula (b) above is not particularly limited but is preferably from 0 to 70 mol %, more preferably from 0 to 60 mol %, even more preferably from 0 to 40 mol %, and particularly preferably from 1 to 15 mol %, relative to a total amount (100 mol %) of the hydrolyzable silane compound that is used.

Furthermore, the ratio (ratio of a total amount) of the compound represented by Formula (a) and the compound represented by Formula (b) relative to a total amount (100 mol %) of the hydrolyzable silane compound that is used is preferably from 60 to 100 mol %, more preferably from 70 to 100 mol %, and even more preferably from 80 to 100 mol %.

In addition, in a case where two or more types of the hydrolyzable silane compounds are used in combination, the hydrolysis and condensation reaction of these hydrolyzable silane compounds can be performed simultaneously or sequentially. The order of the reactions when performed sequentially is not particularly limited.

The hydrolysis and condensation reaction of the hydrolyzable silane compound may be performed in a single step or may be performed in two or more steps, but in order to efficiently produce the polyorganosilsesquioxane according to an embodiment of the present invention, the hydrolysis and condensation reaction are preferably performed in two or more steps (preferably two steps). An aspect in which the hydrolysis and condensation reaction of the hydrolyzable silane compound are performed in two steps is described below, but the method for producing the polyorganosilsesquioxane according to an embodiment of the present invention is not limited thereto.

When the hydrolysis and condensation reaction according to an embodiment of the present invention are performed in two steps, preferably, in the first hydrolysis and condensation reaction, a polyorganosilsesquioxane (hereinafter, referred to as an “intermediate polyorganosilsesquioxane”) having the abovementioned [T3 forms/T2 forms] ratio from 5 to less than 20, and the number average molecular weight from 1000 to 3000 is formed, and in the second hydrolysis and condensation reaction, the polyorganosilsesquioxane according to an embodiment of the present invention can be obtained by subjecting the intermediate polyorganosilsesquioxane to yet another hydrolysis and condensation reaction.

The hydrolysis and condensation reaction of the first step can be performed in the presence or absence of a solvent. Among these, the hydrolysis and condensation reaction are preferably performed in the presence of a solvent. Examples of the solvent include aromatic hydrocarbons, such as benzene, toluene, xylene, and ethylbenzene; ethers, such as diethyl ether, dimethoxyethane, tetrahydrofuran, and dioxane; ketones, such as acetone, methyl ethyl ketone, and methyl isobutyl ketone; esters, such as methyl acetate, ethyl acetate, isopropyl acetate, and butyl acetate; amides, such as N,N-dimethylformamide and N,N-dimethylacetamide; nitriles, such as acetonitrile, propionitrile, and benzonitrile; and alcohols, such as methanol, ethanol, isopropyl alcohol, and butanol. Among these, the solvent is preferably a ketone or an ether. In addition, one type of the solvent can be used alone, or two or more types thereof can be used in combination.

The usage amount of the solvent in the hydrolysis and condensation reaction of the first step is not particularly limited and can be appropriately adjusted in a range from 0 to 2000 parts by weight relative to 100 parts by weight of a total amount of the hydrolyzable silane compound, according to a desired reaction time or the like.

The hydrolysis and condensation reaction of the first step are preferably carried out in the presence of a catalyst and water. The catalyst may be an acid catalyst or an alkali catalyst, but an alkali catalyst is preferable in order to suppress degradation of the polymerizable functional group, such as an epoxy group. Examples of the acid catalyst include mineral acids, such as hydrochloric acid, sulfuric acid, nitric acid, phosphoric acid, and boric acid; phosphate esters; carboxylic acids, such as acetic acid, formic acid, and trifluoroacetic acid; sulfonic acids, such as methanesulfonic acid, trifluoromethanesulfonic acid, and p-toluenesulfonic acid; solid acids, such as activated clay; and Lewis acids, such as iron chloride. Examples of the alkali catalyst include alkali metal hydroxides, such as lithium hydroxide, sodium hydroxide, potassium hydroxide, and cesium hydroxide; alkaline earth metal hydroxides, such as magnesium hydroxide, calcium hydroxide, and barium hydroxide; alkali metal carbonates, such as lithium carbonate, sodium carbonate, potassium carbonate, and cesium carbonate; alkaline earth metal carbonates, such as magnesium carbonate; alkali metal hydrogencarbonates, such as lithium hydrogencarbonate, sodium hydrogencarbonate, potassium hydrogencarbonate, and cesium hydrogencarbonate; alkali metal organic acid salts (for example, acetates), such as lithium acetate, sodium acetate, potassium acetate, and cesium acetate; alkaline earth metal organic acid salts (for example, acetates), such as magnesium acetate; alkali metal alkoxides, such as lithium methoxide, sodium methoxide, sodium ethoxide, sodium isopropoxide, potassium ethoxide, and potassium t-butoxide; alkali metal phenoxides, such as sodium phenoxide; amines (tertiary amines), such as triethylamine, N-methylpiperidine, 1,8-diazabicyclo[5.4.0]undec-7-ene, and 1,5-diazabicyclo[4.3.0]non-5-ene; and nitrogen-containing heterocyclic aromatic compounds, such as pyridine, 2,2′-bipyridyl, and 1,10-phenanthroline. Here, one type of the catalyst can be used alone, or two or more types thereof can be used in combination. In addition, the catalyst can be used in a state of being dissolved or dispersed in water, a solvent, or the like.

The usage amount of the catalyst in the hydrolysis and condensation reaction of the first step is not particularly limited and can be appropriately adjusted in a range from 0.002 to 0.200 mol relative to a total amount of 1 mol of the hydrolyzable silane compound.

The usage amount of water during the hydrolysis and condensation reaction of the first step is not particularly limited and can be appropriately adjusted in a range from 0.5 to 20 mol relative to a total amount of 1 mol of the hydrolyzable silane compound.

The method for adding water in the hydrolysis and condensation reaction of the first step is not particularly limited, and the total amount (total usage amount) of water to be used may be added all at once or may be added sequentially. When water is added sequentially, it may be added continuously or intermittently.

As the reaction conditions for the hydrolysis and condensation reaction of the first step, it is particularly important to select reaction conditions such that the above [T3 forms/T2 forms] ratio in the intermediate polyorganosilsesquioxane is not less than 5 and less than 20. The reaction temperature of the hydrolysis and condensation reaction of the first step is not particularly limited but is preferably from 40 to 100° C. and more preferably from 45 to 80° C. Controlling the reaction temperature to the above range tends to facilitate a more efficient control of the above [T3 forms/T2 forms] ratio to not less than 5 and less than 20. In addition, the reaction time of the hydrolysis and condensation reaction of the first step is not particularly limited, but is preferably from 0.1 to 10 hours and more preferably from 1.5 to 8 hours. Furthermore, the hydrolysis and condensation reaction of the first step can be performed under normal pressure, or can be performed under increased pressure or reduced pressure. Here, the atmosphere when performing the hydrolysis and condensation reaction of the first step is not particularly limited, and for example, the reaction may be performed in any of an inert gas atmosphere, such as a nitrogen atmosphere or an argon atmosphere, or in the presence of oxygen, such as in the air. However, the hydrolysis and condensation reaction is preferably performed in an inert gas atmosphere.

The intermediate polyorganosilsesquioxane can be obtained by the hydrolysis and condensation reaction of the first step. After completion of the hydrolysis and condensation reaction of the first step, the catalyst is preferably neutralized to prevent degradation of the polymerizable functional group, such as ring-opening of the epoxy group. The intermediate polyorganosilsesquioxane may be separated and purified through, for example, a separation means such as water washing, acid washing, alkali washing, filtration, concentration, distillation, extraction, crystallization, recrystallization, and column chromatography, or a separation means that is a combination thereof.

The polyorganosilsesquioxane according to an embodiment of the present invention can be produced by subjecting the intermediate polyorganosilsesquioxane obtained by the hydrolysis and condensation reaction of the first step to a hydrolysis and condensation reaction of a second step.

The hydrolysis and condensation reaction of the second step can be performed in the presence or absence of a solvent. When the hydrolysis and condensation reaction of the second step is performed in the presence of a solvent, a solvent given as an example with regard to the hydrolysis and condensation reaction of the first step can be used. As the solvent of the hydrolysis and condensation reaction of the second step, the intermediate polyorganosilsesquioxane containing the reaction solvent and extraction solvent of the hydrolysis and condensation reaction of the first step may be used as is or may be partially distilled away and used. In addition, one type of the solvent can be used alone, or two or more types thereof can be used in combination.

In a case where a solvent is used in the hydrolysis and condensation reaction of the second step, the usage amount thereof is not particularly limited, and can be appropriately adjusted in a range from 0 to 2000 parts by weight relative to 100 parts by weight of the intermediate polyorganosilsesquioxane, according to a desired reaction time or the like.

The hydrolysis and condensation reaction of the second step is preferably carried out in the presence of a catalyst and water. The catalyst for the hydrolysis and condensation reaction of the first step can be used as the catalyst above. To suppress degradation of polymerizable functional groups such as an epoxy group, the catalyst is preferably an alkali catalyst, more preferably an alkali metal hydroxide such as sodium hydroxide, potassium hydroxide, or cesium hydroxide, or a carbonate of an alkali metal such as lithium carbonate, sodium carbonate, potassium carbonate, or cesium carbonate. Here, one type of the catalyst can be used alone, or two or more types thereof can be used in combination. In addition, the catalyst can be used in a state of being dissolved or dispersed in water, a solvent, or the like.

The amount of the catalyst used in the hydrolysis and condensation reaction of the second step is not particularly limited, and can be appropriately adjusted within a range of preferably from 0.01 to 10000 ppm, and more preferably from 0.1 to 1000 ppm, relative to the intermediate polyorganosilsesquioxane (1000000 ppm).

The amount of water used during the hydrolysis and condensation reaction of the second step is not particularly limited, and can be appropriately adjusted within a range of preferably from 10 to 100000 ppm, and more preferably from 100 to 20000 ppm, relative to the intermediate polyorganosilsesquioxane (1000000 ppm), If the usage amount of water is greater than 100000 ppm, the [T3 forms/T2 forms] ratio and number average molecular weight of the polyorganosilsesquioxane may not be easily controlled to the predetermined ranges.

The method for adding water in the hydrolysis and condensation reaction of the second step is not particularly limited, and the total amount of water to be used (total usage amount) may be added all at once or may be added sequentially. When water is added sequentially, it may be added continuously or intermittently.

As the reaction conditions for the hydrolysis and condensation reaction of the second step, it is particularly important to select reaction conditions such that the above [T3 forms/T2 forms] ratio in the polyorganosilsesquioxane according to an embodiment of the present invention is from 20 to 500, and the number average molecular weight is from 2500 to 50000. The reaction temperature of the hydrolysis and condensation reaction of the second step fluctuates depending on the catalyst that is used, and is not particularly limited, but is preferably from 5 to 200° C., and more preferably from 30 to 100° C. When the reaction temperature is controlled to the above range, the [T3 forms/T2 forms] ratio and the number average molecular weight tend to be more efficiently controlled to the desired ranges. In addition, the reaction time of the hydrolysis and condensation reaction of the second step is not particularly limited, but is preferably from 0.5 to 1000 hours, and more preferably from 1 to 500 hours.

Additionally, sampling may be performed at an appropriate time while the hydrolysis and condensation reaction are carried out within the reaction temperature range described above, and the reaction is carried out while the [T3 forms/T2 forms] ratio and number average molecular weight are monitored. Thus, the polyorganosilsesquioxane according to an embodiment of the present invention having the desired [T3 forms/T2 forms] ratio and number average molecular weight can be formed.

Furthermore, the hydrolysis and condensation reaction of the second step can be performed under normal pressure, or can be performed under increased pressure or reduced pressure. Here, the atmosphere when performing the hydrolysis and condensation reaction of the second step is not particularly limited, and for example, the reaction may be performed in any of an inert gas atmosphere, such as a nitrogen atmosphere or an argon atmosphere, or in the presence of oxygen, such as in the air. However, the hydrolysis and condensation reaction is preferably performed in an inert gas atmosphere.

The polyorganosilsesquioxane according to an embodiment of the present invention can be obtained by the hydrolysis and condensation reaction of the second step. After completion of the hydrolysis and condensation reaction of the second step, the catalyst is preferably neutralized to prevent degradation of the polymerizable functional group, such as ring-opening of the epoxy group. The polyorganosilsesquioxane according to an embodiment of the present invention may be separated and purified through, for example, a separation means such as water washing, acid washing, alkali washing, filtration, concentration, distillation, extraction, crystallization, recrystallization, and column chromatography, or a separation means that is a combination thereof.

The polyorganosilsesquioxane according to an embodiment of the present invention has the configuration described above, and therefore the uncured or semi-cured hard coat layer coated with the curable composition containing the polyorganosilsesquioxane as an essential component is tack-free, and blocking resistance is improved, and thus winding onto a roll and handling are facilitated, and for example, the polyorganosilsesquioxane can be suitably used as a component of a hard coat layer of an in-mold injection transfer film. A cured product that exhibits high surface hardness and heat resistance, and excels in flexibility and processability can be formed by curing the curable composition. Furthermore, a cured product having excellent adhesion can be formed.

### Curable Composition

The curable composition according to an embodiment according to an embodiment of the present invention is a curable composition (curable resin composition) containing the above-described polyorganosilsesquioxane according to an embodiment of the present invention as an essential component. As described below, the curable composition according to an embodiment of the present invention may further contain other components such as a curing catalyst (in particular, a photocationic polymerization initiator or a radically polymerizable initiator), a surface conditioner, or a surface modifier.

Note that in the curable composition of an embodiment according to an embodiment of the present invention, one type of the polyorganosilsesquioxane according to an embodiment of the present invention can be used alone, or two or more types can be used in combination.

The content amount (blended amount) of the polyorganosilsesquioxane according to an embodiment of the present invention in the curable composition according to an embodiment of the present invention is not particularly limited, but is preferably from 70 wt. % to less than 100 wt. %, more preferably from 80 to 99.8 wt. %, and even more preferably from 90 to 99.5 wt. %, relative to a total amount (100 wt. %) of the curable composition excluding the solvent. Setting the content amount of the polyorganosilsesquioxane according to an embodiment of the present invention to 70 wt. % or greater tends to further improve the surface hardness and adhesion of the cured product. On the other hand, when the content amount of the polyorganosilsesquioxane according to an embodiment of the present invention is set to less than 100 wt. %, a curing catalyst can be contained, and thereby curing of the curable composition tends to advance more efficiently.

The ratio of the polyorganosilsesquioxane according to an embodiment of the present invention relative to the total amount (100 wt. %) of cationically curable compound or radically curable compound contained in the curable composition according to an embodiment of the present invention is not particularly limited, but is preferably from 70 to 100 wt. %, more preferably from 75 to 98 wt. %, and even more preferably from 80 to 95 wt. %. Setting the content amount of the polyorganosilsesquioxane according to an embodiment of the present invention to 70 wt. % or greater tends to further improve the surface hardness and adhesion of the cured product.

The curable composition according to an embodiment according to an embodiment of the present invention preferably includes a curing catalyst. The curing catalyst is particularly preferably a cationic polymerization initiator or a radical polymerization initiator in terms of being able to shorten the curing time until the curable composition becomes tack free.

The cationic polymerization initiator is a compound that can initiate or accelerate a cationic polymerization reaction of a cationically curable compound such as the polyorganosilsesquioxane according to an embodiment of the present invention. The cationic polymerization initiator is not particularly limited, and examples thereof include photocationic polymerization initiators (photo acid generating agents) and thermal cationic polymerization initiators (thermal acid generating agents).

Well-known or commonly used photocationic polymerization initiators can be used as the photocationic polymerization initiator, and examples thereof include a sulfonium salt (a salt of a sulfonium ion and an anion), an iodonium salt (a salt of an iodonium ion and an anion), a selenium salt (a salt of a selenium ion and an anion), an ammonium salt (a salt of an ammonium ion and an anion), a phosphonium salt (a salt of a phosphonium ion and an anion), and a salt of a transition metal complex ion and an anion. One type alone or two or more types thereof in combination can be used.

Examples of the sulfonium salt include a triarylsulfonium salt, such as [4-(4-biphenylylthio)phenyl]-4-biphenylylphenyl sulfonium tris(pentafluoroethyl) trifluorophosphate, a triphenylsulfonium salt, a tri-p-tolylsulfonium salt, a tri-o-tolylsulfonium salt, a tris(4-methoxyphenyl)sulfonium salt, a 1-naphthyldiphenylsulfonium salt, a 2-naphthyldiphenyl sulfonium salt, a tris(4-fluorophenyl)sulfonium salt, a tri-1-naphthylsulfonium salt, a tri-2-naphthylsulfonium salt, a tris(4-hydroxyphenyl)sulfonium salt, a diphenyl[4-(phenylthio)phenyl]sulfonium salt, and a 4-(p-tolylthio)phenyl di-(p-phenyl) sulfonium salt; a diarylsulfonium salt, such as a diphenylphenacylsulfonium salt, a diphenyl 4-nitrophenacylsulfonium salt, a diphenylbenzylsulfonium salt, and a diphenylmethylsulfonium salt; a monoarylsulfonium salt, such as a phenylmethylbenzylsulfonium salt, a 4-hydroxyphenylmethylbenzylsulfonium salt, and a 4-methoxyphenylmethylbenzylsulfonium salt; and a trialkylsulfonium salt, such as a dimethylphenacylsulfonium salt, a phenacyltetrahy drothiophenium salt, and a dimethylbenzylsulfonium salt.

As the diphenyl [4-(phenylthio)phenyl]sulfonium salt, for example, diphenyl[4-(phenylthio)phenyl]sulfonium hexafluoroantimonate and (diphenyl[4-(phenylthio)phenyl]sulfonium hexafluorophosphate can be used.

Examples of the iodonium salt include “UV9380C” (trade name, a bis(4-dodecylphenyl)iodonium=hexafluoroantimonate 45% alkyl glycidyl ether solution, available from Momentive Performance Materials Japan LLC), “RHODORSIL PHOTOINITIATOR 2074” (trade name, tetrakis(pentafluorophenyl)borate=[(1-methylethyl)phenyl](methylphenyl)iodonium, available from Rhodia Japan Ltd.), “WPI-124” (trade name, available from Wako Pure Chemical Industries, Ltd.), a diphenyliodonium salt, a di-p-tolyliodonium salt, a bis(4-dodecylphenyl)iodonium salt, and a bis(4-methoxyphenyl)iodonium salt.

Examples of the selenium salt include a triarylselenium salt, such as a triphenylselenium salt, a tri-p-tolylselenium salt, a tri-o-tolylselenium salt, a tris(4-methoxyphenyl)selenium salt, and a 1-naphthyldiphenylselenium salt; a diarylselenium salt, such as a diphenylphenacylselenium salt, a diphenylbenzylselenium salt, and a diphenylmethylselenium salt; a monoarylselenium salt, such as a phenylmethylbenzylselenium salt; and a trialkylselenium salt, such as a dimethylphenacylselenium salt.

Examples of the ammonium salt include a tetraalkyl ammonium salt, such as a tetramethyl ammonium salt, an ethyltrimethyl ammonium salt, a diethyldimethyl ammonium salt, a triethylmethyl ammonium salt, a tetraethyl ammonium salt, a trimethyl-n-propyl ammonium salt, and a trimethyl-n-butyl ammonium salt; a pyrrolidium salt, such as an N,N-dimethylpyrrolidium salt and an N-ethyl-N-methylpyrrolidium salt; an imidazolinium salt, such as an N,N′-dimethylimidazolinium salt and an N,N′-diethylimidazolinium salt; a tetrahydropyrimidium salt, such as an N,N′-dimethyltetrahydropyrimidium salt and an N,N′-diethyltetrahydropyrimidium salt; a morpholinium salt, such as an N,N-dimethylmorpholinium salt and an N,N-diethylmorpholinium salt; a piperidinium salt, such as an N,N-dimethylpiperidinium salt and an N,N-diethylpiperidinium salt; a pyridinium salt, such as an N-methylpyridinium salt and an N-ethylpyridinium salt; an imidazolium salt, such as an N,N′-dimethylimidazolium salt; a quinolium salt, such as an N-methylquinolium salt; an isoquinolium salt, such as an N-methylisoquinolium salt; a thiazonium salt, such as a benzylbenzothiazonium salt; and an acrydium salt, such as a benzylacrydium salt.

Examples of the phosphonium salt include a tetraarylphosphonium salt, such as a tetraphenylphosphonium salt, a tetra-p-tolylphosphonium salt, and a tetrakis(2-methoxyphenyl)phosphonium salt; a triarylphosphonium salt, such as a triphenylbenzylphosphonium salt; and a tetraalkylphosphonium salt, such as a triethylbenzylphosphonium salt, a tributylbenzylphosphonium salt, a tetraethylphosphonium salt, a tetrabutylphosphonium salt, and a triethylphenacylphosphonium salt.

Examples of the salt of the transition metal complex ion include a salt of a chromium complex cation, such as (η5-cyclopentadienyl)(η6-toluene)Cr⁺ and (η5-cyclopentadienyl)(η6-xylene)Cr⁺; and a salt of an iron complex cation, such as (η5-cyclopentadienyl)(η6-toluene)Fe⁺ and (η5-cyclopentadienyl)(η6-xylene)Fe⁺.

Examples of the anion constituting the salt described above include SbF₆⁻, PF₆⁻, BF₄⁻, (CF₃CF₂)₃PF₃⁻, (CF₃CF₂CF₂)₃PF₃⁻, (C₆F₅)₄B⁻, (C₆F₅)₄Ga⁻, a sulfonate anion (such as a trifluoromethanesulfonate anion, a pentafluoroethanesulfonate anion, a nonafluorobutanesulfonate anion, a methanesulfonate anion, a benzenesulfonate anion, and a p-toluenesulfonate anion), (CF₃SO₂)₃C⁻, (CF₃SO₂)₂N⁻, a perhalogenate ion, a halogenated sulfonate ion, a sulfate ion, a carbonate ion, an aluminate ion, a hexafluorobismuthate ion, a carboxylate ion, an arylborate ion, a thiocyanate ion, and a nitrate ion.

Examples of the thermal cationic polymerization initiator include arylsulfonium salts, aryliodonium salts, allene-ion complexes, quaternary ammonium salts, aluminum chelates, and boron trifluoride amine complexes.

Examples of the arylsulfonium salt include hexafluoroantimonate salts and the like. In the curable composition according to an embodiment of the present invention, commercially available products such as, for example, “SP-66” and “SP-77” (trade names, available from ADEKA Corporation); “SAN-AID SI-60L”, “SAN-AID SI-80 L”, “SAN-AID SI-100L” and “SAN-AID SI-150 L” (trade names, available from Sanshin Chemical Industry Co., Ltd.) can be used. Examples of the aluminum chelate include ethylacetoacetate aluminum diisopropylate and aluminum tris(ethylacetoacetate). Examples of the boron trifluoride amine complex include a boron trifluoride monoethyl amine complex, a boron trifluoride imidazole complex, and a boron trifluoride piperidine complex.

The radical polymerization initiator is a compound that can initiate or accelerate a radical polymerization reaction of a radically curable compound such as the polyorganosilsesquioxane according to an embodiment of the present invention. The radical polymerization initiator is not particularly limited, and examples thereof include photoradical polymerization initiators and thermal radical polymerization initiators.

Examples of the photoradical polymerization initiator include benzophenone, acetophenone benzyl, benzyldimethyl ketone, benzoin, benzoin methyl ether, benzoin ethyl ether, benzoin isopropyl ether, dimethoxyacetophenone, dimethoxy phenylacetophenone, diethoxyacetophenone, diphenyl disulfite, methyl o-benzoylbenzoate, ethyl 4-dimethylaminobenzoate (available from Nippon Kayaku Co., Ltd.; trade name “Kayacure EPA”), 2,4-diethylthioxanthone (available from Nippon Kayaku Co., Ltd., trade name “Kayacure DETX”), 2-methyl-1-[4-(methyl)phenyl]-2-morpholino-propanone-1 (available from Ciba-Geigy AG; trade name “Irgacure 907”), 1-hydroxycyclohexyl phenyl ketone (available from Ciba-Geigy AG, trade name “Irgacure 184”), 2-dimethylamino-2-(4-morpholino) benzoyl-1-phenylpropane, and other such 2-amino-2-benzoyl-1-phenyl alkane compounds, tetra(t-butylperoxy carbonyl) benzophenone, benzil, 2-hydroxy-2-methyl-1-phenyl-propan-1-one, 4,4-bis diethylaminobenzophenone, and other such amino benzene derivatives, 2,2′-bis (2-chlorophenyl)-4,5,4′,5′-tetraphenyl-1,2′-biimidazole (available from Hodagaya Chemical Co., Ltd., trade name “B-CIM”), and other such imidazole compounds, 2,6-bis (trichloromethyl)-4-(4-methoxynaphthalen-1-yl)-1,3,5-triazine, and other such halomethylated triazine compounds, and 2-trichloromethyl-5-(2-benzofuran-2-yl-ethenyl)-1,3,4-oxadiazole, and other such halomethyl oxadiazole compounds. Photosensitizers can also be added as necessary.

Examples of the thermal radical polymerization initiator include hydroperoxides, dialkyl peroxides, peroxy esters, diacyl peroxides, peroxy dicarbonates, peroxy ketals, and ketone peroxides (specifically, benzoyl peroxide, t-butylperoxy-2-ethylhexanoate, 2,5-dimethyl-2,5-di(2-ethylhexanoyl) peroxyhexane, t-butylperoxy benzoate, t-butyl peroxide, cumene hydroperoxide, dicumyl peroxide, di-t-butyl peroxide, 2,5-dimethyl-2,5-dibutyl peroxyhexane, 2,4-dichlorobenzoyl peroxide, 1,4-di(2-t-butylperoxyisopropyl) benzene, 1,1-bis(t-butylperoxy)-3,3,5-trimethylcyclohexane, methylethylketone peroxide, and 1,1,3,3-tetramethylbutyl peroxy-2-ethylhexanoate) and other such organic peroxides.

Note that, in the curable composition of an embodiment according to an embodiment of the present invention, one type of the curing catalyst can be used alone, or two or more types can be used in combination.

The content amount (blended amount) of the curing catalyst in the curable composition according to an embodiment of the present invention is preferably from 0.01 to 3.0 parts by weight, more preferably from 0.05 to 3.0 parts by weight, even more preferably from 0.1 to 1.0 parts by weight, and particularly preferably from 0.3 to 1.0 part by weight, per 100 parts by weight of the polyorganosilsesquioxane according to an embodiment of the present invention. Setting the content amount of the curing catalyst to 0.01 parts by weight or greater can allow the curing reaction to efficiently and sufficiently proceed, and the surface hardness and adhesion of the resulting cured product tend to improve. On the other hand, setting the content amount of the curing catalyst to 3.0 parts by weight or less tends to further improve the storage properties of the curable composition and to prevent coloration of the resulting cured product.

The curable composition according to an embodiment of the present invention may further contain a cationically curable compound other than the polyorganosilsesquioxane according to an embodiment of the present invention (sometimes referred to as an “other cationically curable compound”) and/or a radically curable compound other than the polyorganosilsesquioxane according to an embodiment of the present invention (sometimes referred to as an “other radically curable compound”). The other cationically curable compound is not particularly limited, and a well-known or commonly used cationically curable compound can be used. Examples thereof include an epoxy compound, an oxetane compound, and a vinyl ether compound, other than the polyorganosilsesquioxane according to an embodiment of the present invention. Here, in the curable composition according to an embodiment of the present invention, one type of the other cationically curable compound can be used alone, or two or more types thereof can be used in combination.

For the epoxy compound described above, a well-known or commonly used compound having one or more epoxy groups (oxirane rings) per molecule can be used. The epoxy compound is not particularly limited, and the examples thereof include alicyclic epoxy compounds (alicyclic epoxy resins), aromatic epoxy compounds (aromatic epoxy resins), and aliphatic epoxy compounds (aliphatic epoxy resins).

For the alicyclic epoxy compound, examples include well-known or commonly used compounds that have one or more alicyclic rings and one or more epoxy groups in the molecule. Such an alicyclic epoxy compound is not particularly limited, and the examples include, for example, (1) a compound including an epoxy group (referred to as an “alicyclic epoxy group”) constituted of two adjacent carbon atoms and an oxygen atom that constitute an alicyclic ring in the molecule; (2) a compound in which an epoxy group is directly bonded to an alicyclic ring with a single bond; and (3) a compound including an alicyclic ring and a glycidyl ether group in the molecule (a glycidyl ether type epoxy compound).

Examples of the compound (1) having an alicyclic epoxy group in the molecule include a compound represented by Formula (i) below.

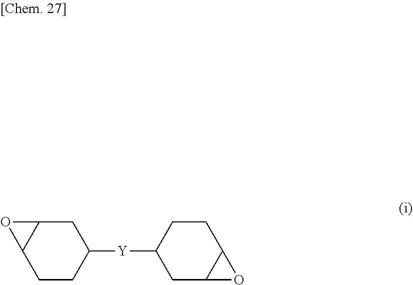

In Formula (i) above, Y represents a single bond or a linking group (a divalent group having one or more atoms). Examples of the linking group include divalent hydrocarbon groups, alkenylene groups in which some or all of the carbon-carbon double bonds are epoxidized, carbonyl groups, ether bonds, ester bonds, carbonate groups, amide groups, and groups in which a plurality thereof are linked.

Examples of the divalent hydrocarbon group include linear or branched alkylene groups having from 1 to 18 carbons and divalent alicyclic hydrocarbon groups. Examples of the linear or branched alkylene group having from 1 to 18 carbons include a methylene group, a methyl methylene group, a dimethyl methylene group, an ethylene group, a propylene group, and a trimethylene group. Examples of the divalent alicyclic hydrocarbon group include a divalent cycloalkylene group (including a cycloalkylidene group), such as a 1,2-cyclopentylene group, a 1,3-cyclopentylene group, a cyclopentylidene group, a 1,2-cyclohexylene group, a 1,3-cyclohexylene group, a 1,4-cyclohexylene group, and a cyclohexylidene group.

Examples of the alkenylene group in the alkenylene group in which some or all of the carbon-carbon double bonds are epoxidized (which may be referred to as an “epoxidized alkenylene group”) include linear or branched alkenylene groups having from 2 to 8 carbons, such as a vinylene group, a propenylene group, a 1-butenylene group, a 2-butenylene group, a butadienylene group, a pentenylene group, a hexenylene group, a heptenylene group, and an octenylene group. In particular, the epoxidized alkenylene group is preferably an alkenylene group in which all of the carbon-carbon double bonds are epoxidized, and more preferably an alkenylene group having from 2 to 4 carbon atoms in which all of the carbon-carbon double bonds are epoxidized.

Representative examples of the alicyclic epoxy compound represented by Formula (i) above include (3,4,3′,4′-diepoxy)bicyclohexyl and compounds represented by Formulae (i-1) to (i-10) below. In Formulae (i-5) and (i-7) below, 1 and m each represent an integer from 1 to 30. R′ in Formula (i-5) below is an alkylene group having from 1 to 8 carbon atoms, and, among these, a linear or branched alkylene group having from 1 to 3 carbon atoms, such as a methylene group, an ethylene group, a propylene group, or an isopropylene group, is preferable. In Formulae (i-9) and (i-10) below, n1 to n6 each represent an integer from 1 to 30. In addition, examples of the alicyclic epoxy compound represented by Formula (i) above include 2,2-bis(3,4-epoxycyclohexyl)propane, 1,2-bis(3,4-epoxycyclohexyl)ethane, 2,3-bis(3,4-epoxycyclohexyl)oxirane, and bis(3,4-epoxycyclohexylmethyl)ether.

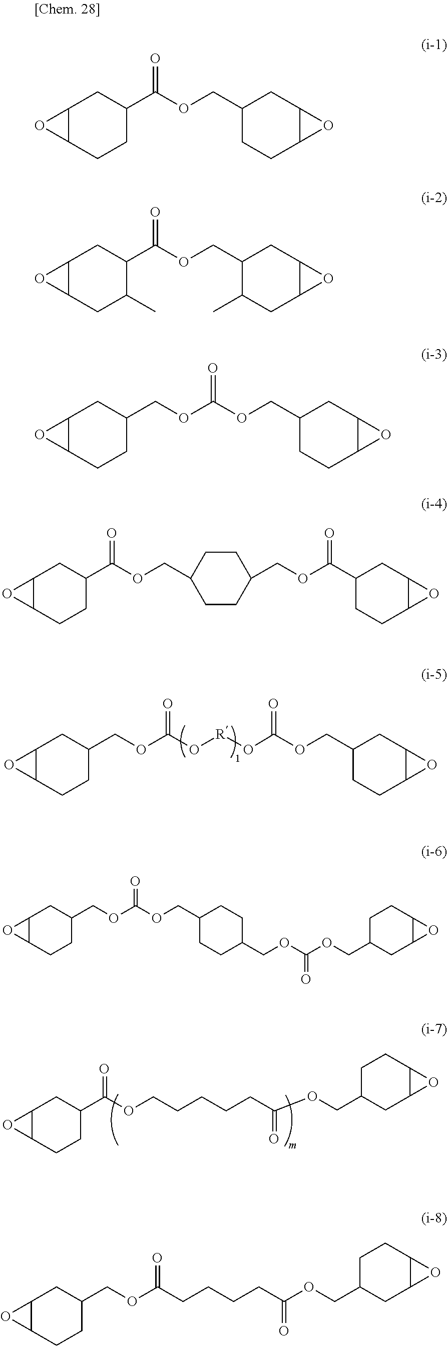

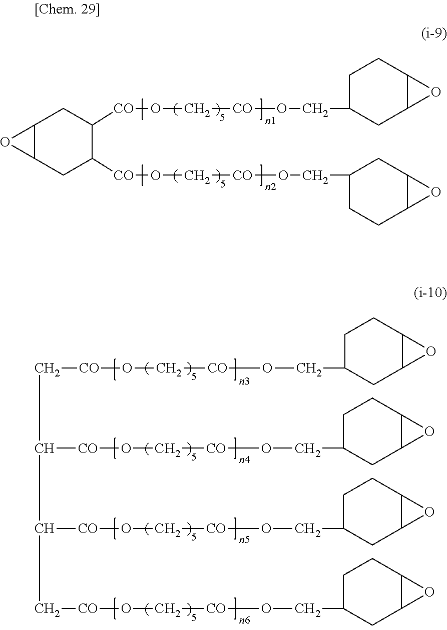

Examples of the compound (2) described above in which an epoxy group is directly bonded to an alicyclic ring with a single bond include a compound represented by Formula (ii) below.

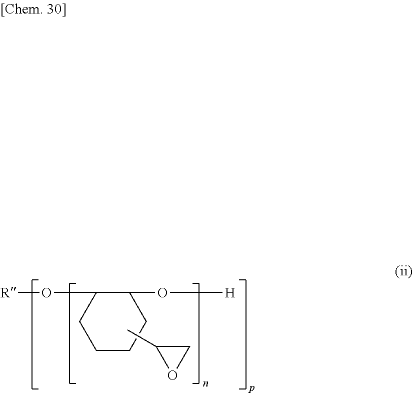

In Formula (ii), R″ is a group resulting from elimination of p hydroxyl groups (—OH) from a structural formula of a p-valent alcohol (p-valent organic group), wherein p and n each represent a natural number. Examples of the p-hydric alcohol [R″(OH)ₚ] include polyhydric alcohols (alcohols having from 1 to 15 carbon atom atoms), such as 2,2-bis(hydroxymethyl)-1-butanol. Here, p is preferably from 1 to 6, and n is preferably from 1 to 30. When p is 2 or greater, n in each group in parentheses (in the outer parentheses) may be the same or different. Examples of the compound represented by Formula (ii) specifically include 1,2-epoxy-4-(2-oxiranyl)cyclohexane adduct of 2,2-bis(hydroxymethyl)-1-butanol [for example, such as the trade name “EHPE3150” (available from Daicel Corporation)].

Examples of the compound (3) described above including an alicyclic ring and a glycidyl ether group in the molecule include glycidyl ethers of alicyclic alcohols (in particular, alicyclic polyhydric alcohols). More particularly, examples thereof include a compound obtained by hydrogenating a bisphenol A type epoxy compound (a hydrogenated bisphenol A type epoxy compound), such as 2,2-bis[4-(2,3-epoxypropoxy)cyclohexyl]propane and 2,2-bis[3,5-dimethyl-4-(2,3-epoxypropoxy)cyclohexyl]propane; a compound obtained by hydrogenating a bisphenol F type epoxy compound (a hydrogenated bisphenol F type epoxy compound), such as bis[o,o-(2,3-epoxypropoxy)cyclohexyl]methane, bis[o,p-(2,3-epoxypropoxy)cyclohexyl]methane, bis[p,p-(2,3-epoxypropoxy)cyclohexyl]methane, and bis[3,5-dimethyl-4-(2,3-epoxypropoxy)cyclohexyl]methane; a hydrogenated bisphenol type epoxy compound; a hydrogenated phenol novolac type epoxy compound; a hydrogenated cresol novolac type epoxy compound; a hydrogenated cresol novolac type epoxy compound of bisphenol A; a hydrogenated naphthalene type epoxy compound; a hydrogenated epoxy compound of an epoxy compound obtained from trisphenolmethane; and a hydrogenated epoxy compound of an aromatic epoxy compound described below.

Examples of the aromatic epoxy compound include an epibis type glycidyl ether type epoxy resin obtained by a condensation reaction of bisphenols (for example, such as bisphenol A, bisphenol F, bisphenol S, and fluorenebisphenol) and an epihalohydrin; a high molecular weight epibis type glycidyl ether type epoxy resin obtained by further subjecting the above epibis type glycidyl ether type epoxy resin to an addition reaction with the bisphenol described above; a novolac alkyl type glycidyl ether type epoxy resin obtained by subjecting a phenol (for example, such as phenol, cresol, xylenol, resorcin, catechol, bisphenol A, bisphenol F, and bisphenol S) and an aldehyde (for example, such as formaldehyde, acetaldehyde, benzaldehyde, hydroxybenzaldehyde, and salicylaldehyde) to a condensation reaction to obtain a polyhydric alcohol, and then further subjecting the polyhydric alcohol to condensation reaction with epihalohydrin; and an epoxy compound in which two phenol skeletons are bonded at the 9-position of the fluorene ring, and glycidyl groups are each bonded directly or via an alkyleneoxy group to an oxygen atom resulting from eliminating a hydrogen atom from a hydroxy group of these phenol skeletons.

Examples of the aliphatic epoxy compound include glycidyl ethers of a q-valent alcohol, the alcohol including no cyclic structure (q is a natural number); glycidyl esters of monovalent or polyvalent carboxylic acids (for example, such as acetic acid, propionic acid, butyric acid, stearic acid, adipic acid, sebacic acid, maleic acid, and itaconic acid); epoxidized materials of fats and oils including a double bond, such as epoxidized linseed oil, epoxidized soybean oil, and epoxidized castor oil; and epoxidized materials of polyolefins (including polyalkadienes), such as epoxidized polybutadiene. Here, examples of the q-valent alcohol including no cyclic structure include monohydric alcohols, such as methanol, ethanol, 1-propyl alcohol, isopropyl alcohol, and 1-butanol; dihydric alcohols, such as ethylene glycol, 1,2-propanediol, 1,3-propanediol, 1,4-butanediol, neopentyl glycol, 1,6-hexanediol, diethylene glycol, triethylene glycol, tetraethylene glycol, dipropylene glycol, polyethylene glycol, and polypropylene glycol; and trihydric or higher polyhydric alcohols, such as glycerin, diglycerin, erythritol, trimethylolethane, trimethylolpropane, pentaerythritol, dipentaerythritol, and sorbitol. In addition, the q-hydric alcohol may be a polyether polyol, a polyester polyol, a polycarbonate polyol, a polyolefin polyol, or the like.

The oxetane compound includes well known or commonly used compounds including one or more oxetane rings in the molecule and is not particularly limited. Examples thereof include 3,3-bis(vinyloxymethyl)oxetane, 3-ethyl-3-(hydroxymethyl)oxetane, 3-ethyl-3-(2-ethylhexyloxymethyl)oxetane, 3-ethyl-3-[(phenoxy)methyl]oxetane, 3-ethyl-3-(hexyloxymethyl)oxetane, 3-ethyl-3-(chloromethyl)oxetane, 3,3-bis(chloromethyl)oxetane, 1,4-bis[(3-ethyl-3-oxetanylmethoxy)methyl]benzene, bis{[1-ethyl(3-oxetanyl)]methyl}ether, 4,4′-bis[(3-ethyl-3-oxetanyl)methoxymethyl]bicyclohexyl, 1,4-bis[(3-ethyl-3-oxetanyl)methoxymethyl]cyclohexane, 1,4-bis{[(3-ethyl-3-oxetanyl)methoxy]methyl}benzene, 3-ethyl-3-{[(3-ethyloxetane-3-yl)methoxy]methyl}oxetane, xylylenebisoxetane, 3-ethyl-3-{[3-(triethoxysilyl)propoxy]methyl}oxetane, oxetanylsilsesquioxane, and phenol novolac oxetane.

The vinyl ether compound is not particularly limited, and a well known or commonly used compound including one or more vinyl ether groups in the molecule can be used. Examples thereof include 2-hydroxyethyl vinyl ether (ethyleneglycol monovinyl ether), 3-hydroxypropyl vinyl ether, 2-hydroxypropyl vinyl ether, 2-hydroxyisopropyl vinyl ether, 4-hydroxybutyl vinyl ether, 3-hydroxybutyl vinyl ether, 2-hydroxybutyl vinyl ether, 3-hydroxyisobutyl vinyl ether, 2-hydroxyisobutyl vinyl ether, 1-methyl-3-hydroxypropyl vinyl ether, 1-methyl-2-hydroxypropyl vinyl ether, 1-hydroxymethylpropyl vinyl ether, 4-hydroxycyclohexyl vinyl ether, 1,6-hexanediol monovinyl ether, 1,6-hexanediol divinyl ether, 1,8-octanediol divinyl ether, 1,4-cyclohexanedimethanol monovinyl ether, 1,4-cyclohexanedimethanol divinyl ether, 1,3-cyclohexanedimethanol monovinyl ether, 1,3-cyclohexanedimethanol divinyl ether, 1,2-cyclohexanedimethanol monovinyl ether, 1,2-cyclohexanedimethanol divinyl ether, p-xylene glycol monovinyl ether, p-xylene glycol divinyl ether, m-xylene glycol monovinyl ether, m-xylene glycol divinyl ether, o-xylene glycol monovinyl ether, o-xylene glycol divinyl ether, ethylene glycol divinyl ether, diethylene glycol monovinyl ether, diethylene glycol divinyl ether, triethylene glycol monovinyl ether, triethylene glycol divinyl ether, tetraethylene glycol monovinyl ether, tetraethylene glycol divinyl ether, pentaethylene glycol monovinyl ether, pentaethylene glycol divinyl ether, oligoethylene glycol monovinyl ether, oligoethylene glycol divinyl ether, polyethylene glycol monovinyl ether, polyethylene glycol divinyl ether, dipropylene glycol monovinyl ether, dipropylene glycol divinyl ether, tripropylene glycol monovinyl ether, tripropylene glycol divinyl ether, tetrapropylene glycol monovinyl ether, tetrapropylene glycol divinyl ether, pentapropylene glycol monovinyl ether, pentapropylene glycol divinyl ether, oligopropyleneglycol monovinyl ether, oligopropyleneglycol divinyl ether, polypropyleneglycol monovinyl ether, polypropyleneglycol divinyl ether, isosorbide divinyl ether, oxanorbornene divinyl ether, phenyl vinyl ether, n-butyl vinyl ether, isobutyl vinyl ether, octyl vinyl ether, cyclohexyl vinyl ether, hydroquinone divinyl ether, 1,4-butanediol divinyl ether, cyclohexanedimethanol divinyl ether, trimethylolpropane divinyl ether, trimethylolpropane trivinyl ether, bisphenol A divinyl ether, bisphenol F divinyl ether, hydroxyoxanorbornanemethanol divinyl ether, 1,4-cyclohexanediol divinyl ether, pentaerythritol trivinyl ether, pentaerythritol tetravinyl ether, dipentaerythritol pentavinyl ether, and dipentaerythritol hexavinyl ether.

In the curable composition according to an embodiment of the present invention, a vinyl ether compound is preferably used as another cationically curable compound in combination with the polyorganosilsesquioxane according to an embodiment of the present invention. Through this, the surface hardness of the resulting cured product tends to further increase. In particular, when the curable composition according to an embodiment of the present invention is cured by irradiation with active energy rays (in particular ultraviolet rays), a cured product with a very high surface hardness can be formed advantageously with good productivity even when the irradiation dose of the active energy rays is reduced. Therefore, the production line speeds for a cured product, an in-mold injection molded article and a hard coat film, which use the transfer film according to an embodiment of the present invention, can be further increased, and the productivity for these is further improved.

Furthermore, when a vinyl ether compound having one or more hydroxyl groups per molecule is used in particular as another cationically curable compound, a cured product having higher surface hardness and superior thermal yellowing resistance (a property in which yellowing due to heating is less likely to occur) can be advantageously formed. As a result, a cured product with even higher quality and higher durability, an in-mold injection molded article and a hard coat film, which use the transfer film according to an embodiment of the present invention, are obtained. The number of hydroxyl groups per molecule of the vinyl ether compound having one or more hydroxyl groups per molecule is not particularly limited, but is preferably from 1 to 4, and is more preferably 1 or 2. More specifically, examples of vinyl ether compounds having one or more hydroxyl group per molecule include 2-hydroxyethyl vinyl ether (ethylene glycol monovinyl ether), 3-hydroxypropyl vinyl ether, 2-hydroxypropyl vinyl ether, 2-hydroxyisopropyl vinyl ether, 4-hydroxybutyl vinyl ether, 3-hydroxybutyl vinyl ether, 2-hydroxybutyl vinyl ether, 3-hydroxyisobutyl vinyl ether, 2-hydroxyisobutyl vinyl ether, 1-methyl-3-hydroxypropyl vinyl ether, 1-methyl-2-hydroxypropyl vinyl ether, 1-hydroxymethylpropyl vinyl ether, 4-hydroxycyclohexyl vinyl ether, 1,6-hexanediol monovinyl ether, 1,8-octanediol divinyl ether, 1,4-cyclohexane dimethanol monovinyl ether, 1,3-cyclohexane dimethanol monovinyl ether, 1,2-cyclohexane dimethanol monovinyl ether, p-xylene glycol monovinyl ether, m-xylene glycol monovinyl ether, o-xylene glycol monovinyl ether, diethylene glycol monovinyl ether, triethylene glycol monovinyl ether, tetraethylene glycol monovinyl ether, pentaethylene glycol monovinyl ether, oligoethylene glycol monovinyl ether, polyethylene glycol monovinyl ether, tripropylene glycol monovinyl ether, tetrapropylene glycol monovinyl ether, pentapropylene glycol monovinyl ether, oligopropylene glycol monovinyl ether, polypropylene glycol monovinyl ether, pentaerythritol trivinyl ether, and dipentaerythritol pentavinyl ether.

The other radically curable compound is not particularly limited, and a well-known or commonly used radically curable compound can be used. Examples thereof include (meth)acrylic compounds other than the polyorganosilsesquioxane according to an embodiment of the present invention. Here, one type of the other radically curable compound can be used alone in the curable composition according to an embodiment of the present invention, or two or more types thereof can be used in combination therein.

The (meth)acrylic compound is not particularly limited, and a known or commonly used compound having one or more (meth)acrylic groups per molecule can be used, including, for example, trimethylolpropane tri(meth)acrylate, trimethylolethane tri(meth)acrylate, tetramethylolmethane tri(meth)acrylate, tetramethylolmethane tetra(meth)acrylate, pentaglycerol tri(meth)acrylate, pentaerythritol di(meth)acrylate, pentaerythritol tri(meth)acrylate, pentaerythritol tetra(meth)acrylate, glycerin tri(meth)acrylate, dipentaerythritol tri(meth)acrylate, dipentaerythritol tetra(meth)acrylate, dipentaerythritol penta(meth)acrylate, dipentaerythritol hexa(meth)acrylate, tris((meth)acryloyloxyethyl)isocyanurate, and other such polyfunctional acrylates.

The content amount (blended amount) of the other cationically curable compound and/or other radically curable compound in the curable composition according to an embodiment of the present invention is not particularly limited, but is preferably 50 wt. % or less (for example, from 0 to 50 wt. %), more preferably 30 wt. % or less (for example, from 0 to 30 wt. %), and even more preferably 10 wt. % or less, relative to a total amount of the polyorganosilsesquioxane according to an embodiment of the present invention, the other cationically curable compound, and the other radically curable compound (100 wt. %; total amount of cationically curable compounds and radically curable compounds). Setting the content amount of the other cationically curable compound and/or other radically curable compound to 50 wt. % or less (in particular, 10 wt. % or less) tends to further improve the scratch resistance of the cured product. On the other hand, setting the content amount of the other cationically curable compound and/or other radically curable compound to 10 wt. % or greater can impart, in some cases, a desired performance to the curable composition and the cured product (for example, fast curing properties and a viscosity adjustment of the curable composition).

The content amount (blended amount) of the vinyl ether compound (in particular, the vinyl ether compound having one or more hydroxyl groups per molecule) in the curable composition according to an embodiment of the present invention is not particularly limited, but is preferably from 0.01 to 10 wt. %, more preferably from 0.05 to 9 wt. %, and even more preferably from 1 to 8 wt. %, relative to a total amount of the polyorganosilsesquioxane, the other cationically curable compound and the other radically curable compound (100 wt. %; the total amount of cationically curable compounds and radically curable compounds). When the content amount of the vinyl ether compound is controlled to the aforementioned range, the surface hardness of the cured product is further increased, and a cured product with a very high surface hardness tends to be obtained even when the irradiation dose of the active energy rays (for example, ultraviolet rays) is reduced. In particular, when the content amount of the vinyl ether compound having one or more hydroxyl groups per molecule is controlled to the aforementioned range, in addition to the surface hardness of the cured product being particularly high, the thermal yellowing resistance thereof tends to further improve.

The curable composition according to an embodiment of the present invention may further include a commonly used additive as an additional optional component, such as an inorganic filler, such as precipitated silica, wet silica, fumed silica, calcined silica, titanium oxide, alumina, glass, quartz, aluminosilicic acid, iron oxide, zinc oxide, calcium carbonate, carbon black, silicon carbide, silicon nitride, and boron nitride; an inorganic filler obtained by treating the above filler with an organosilicon compound, such as an organohalosilane, organoalkoxysilane, and organosilazane; an organic resin fine powder, such as a silicone resin, an epoxy resin, and a fluororesin; a filler, such as a conductive metal powder of silver, copper, or the like, a curing auxiliary, a solvent (such as an organic solvent), a stabilizer (such as an antioxidant, an ultraviolet absorber, a light-resistant stabilizer, a heat stabilizer, and a heavy metal inactivator), a flame retardant (such as a phosphorus-based flame retardant, a halogen-based flame retardant, and an inorganic flame retardant), a flame retardant auxiliary, a reinforcing material (such as an additional filler), a nucleating agent, a coupling agent (such as a silane coupling agent), a lubricant, a wax, a plasticizer, a releasing agent, an impact modifier, a hue modifier, a transparentizing agent, a rheology modifier (such as a fluidity modifier), a processability modifier, a colorant (such as a dye and a pigment), an antistatic agent, a dispersant, a surface conditioner (an antifoaming agent, a leveling agent, a welling-up prevention agent), a surface modifier (such as a slipping agent), a matting agent, an antifoaming agent, a foam inhibitor, a deforming agent, an antibacterial agent, a preservative, a viscosity modifier, a thickening agent, a photosensitizer, and a foaming agent. One type alone or two or more types of these additives in combination can be used.

The curable composition according to an embodiment of the present invention can be prepared by, but not particularly limited to, agitating and mixing each component described above at room temperature or under heating as necessary. Here, the curable composition according to an embodiment of the present invention can be used as a one-part composition, which contains each component mixed beforehand and is used as is, or alternatively, used as a multi-part (for example, two-part) composition of which two or more components are separately stored and then mixed at a predetermined ratio before use.

The curable composition according to an embodiment of the present invention is not particularly limited, but is preferably a liquid at normal temperature (about 25° C.). More specifically, a liquid of the curable composition according to an embodiment of the present invention diluted with a solvent to 20% [in particular, a curable composition (solution) having a ratio of methyl isobutyl ketone of 20 wt. %] has a viscosity at 25° C. of preferably from 300 to 20000 mPa·s, more preferably from 500 to 10000 mPa·s, and even more preferably from 1000 to 8000 mPa·s. The curable composition with the viscosity of 300 mPa·s or greater tends to further improve the heat resistance of the cured product. On the other hand, the curable composition with the viscosity of 20000 mPa·s or less facilitates the preparation and handling of the curable composition, and tends to less likely to leave residual bubbles in the cured product. Here, the viscosity of the curable composition according to an embodiment of the present invention is measured using a viscometer (trade name “MCR301”, available from Anton Paar GmbH) under conditions of a swing angle of 5%, a frequency from 0.1 to 100 (l/s), and a temperature of 25° C.

### Cured Product

By allowing the polymerization reaction of the cationically curable compound or radically curable compound (such as the polyorganosilsesquioxane according to an embodiment of the present invention) in the curable composition according to an embodiment of the present invention to proceed, the curable composition can be cured, and a cured product (may be referred to as a “cured product according to an embodiment of the present invention”) can be obtained. The curing method is not particularly limited, and can be appropriately selected from well-known methods, including, for example, a method of irradiation with active energy rays and/or heating. As the active energy rays, for example, any of infrared rays, visible rays, ultraviolet rays, X-rays, an electron beam, an α-ray, a β-ray, and a γ-ray can be used. Among these, ultraviolet rays are preferred in terms of excellent handling.

The conditions for curing the curable composition according to an embodiment of the present invention by irradiating with the active energy rays (active energy ray irradiation conditions) are not particularly limited and can be appropriately adjusted according to the type and energy of the active energy rays to be irradiated, and the shape and size of the cured product. In the case of irradiation with ultraviolet rays, however, the curing conditions are for example, preferably set to approximately from 1 to 1000 mJ/cm². In addition, for example, a high-pressure mercury lamp, an ultra high-pressure mercury lamp, a xenon lamp, a carbon arc, a metal halide lamp, the sunlight, an LED lamp, and a laser can be used for irradiation with active energy rays. After irradiation with active energy rays, the curing reaction can be further allowed to proceed by further subjecting to a heat treatment (annealing and aging).

The conditions when curing the curable composition according to an embodiment of the present invention by heating are not particularly limited but are, for example, preferably from 30 to 200° C., and more preferably from 50 to 190° C. The curing time can be appropriately set.

As described above, the curable composition according to an embodiment of the present invention has high surface hardness and heat resistance, and can form a cured product having excellent flexibility and processability. Therefore, the curable composition according to an embodiment of the present invention can be particularly preferably used as a “hard coat layer forming curable composition” (sometimes referred to as “hard coat solution” or a “hard coat agent”) for forming the hard coat layer in a hard coat film. The hard coat film having a hard coat layer formed from a curable composition according to an embodiment of the present invention using the composition thereof as a hard coat layer forming curable composition, has flexibility while maintaining high hardness and high heat resistance, and can be produced and processed with a roll-to-roll process.

In addition, the curable composition according to an embodiment of the present invention can form a hard coat layer, wherein the surface of the uncured or semi-cured hard coat layer coated and dried on a release layer provided on a substrate is tack-free, and blocking resistance is improved, and therefore winding in a roll shape and handling are facilitated, and furthermore, a hard coat layer having a high surface hardness can be formed by transferring and curing the hard coat layer to the surface of a molded article. Therefore, the curable composition according to an embodiment of the present invention can be particularly preferably used as a hard coat layer forming curable composition for forming a hard coat layer of a transfer film used for in-mold injection molding.

### Transfer Film

The transfer film according to an embodiment of the present invention is a film having a substrate and an uncured or semi-cured hard coat layer on a release layer formed on at least one surface of the substrate, wherein the uncured or semi-cured hard coat layer is formed from the curable composition according to an embodiment of the present invention (hard coat layer forming curable composition; may be referred to hereafter as a “hard coat agent according to an embodiment of the present invention”). Here, “uncured” means a state in which the polymerizable functional groups of the polyorganosilsesquioxane according to an embodiment of the present invention contained in the hard coat layer forming curable composition (hard coat agent) according to an embodiment of the present invention are yet to undergo a polymerization reaction. Furthermore, “semi-cured” refers to a state in which some of the polymerizable functional group undergo a polymerization reaction, and unreacted polymerizable functional groups remain. Note that in the present specification, an uncured or semi-cured hard coat layer formed from the curable composition (hard coat agent) according to an embodiment of the present invention may be referred to simply as a “hard coat layer”, and a hard coat layer that is transferred and cured onto a molded article may be referred to as a “cured hard coat layer”.

The substrate in the transfer film according to an embodiment of the present invention is a substrate of a transfer film, and refers to a portion constituting an area other than the transfer layer containing the hard coat layer according to an embodiment of the present invention. Here, the transfer layer refers to a layer excluding the substrate on which the release layer is formed, and is a portion that is transferred to a surface of the molded article. The substrate is not particularly limited, and a well-known or commonly used substrate can be used, such as a plastic substrate, a metal substrate, a ceramic substrate, a semiconductor substrate, a glass substrate, a paper substrate, a wood substrate (wooden substrate), and a substrate having a surface that is a coated surface. Among these, a plastic substrate (a substrate constituted of a plastic material) is preferred.

The plastic material constituting the plastic substrate is not particularly limited. Examples thereof include various plastic materials, such as polyesters, such as polyethylene terephthalate (PET) and polyethylene naphthalate (PEN); polyimides; polycarbonates; polyamides; polyacetals; polyphenylene oxides; polyphenylene sulfides; polyethersulfones; polyetheretherketones; cyclic polyolefins, such as homopolymers of norbornene-based monomers (such as addition polymers and ring-opened polymers), copolymers of a norbornene-based monomer and an olefin-based monomer (such as cyclic olefin copolymers, such as addition polymers and ring-opened polymers), such as a copolymer of norbornene and ethylene, and derivatives thereof; vinyl-based polymers (for example, acrylic resins, such as polymethyl methacrylates (PMMA), polystyrenes, polyvinyl chlorides, and acrylonitrile-styrene-butadiene resins (ABS resins)); vinylidene polymers (for example, such as polyvinylidene chlorides); cellulose resins, such as triacetyl cellulose (TAC); epoxy resins; phenolic resins; melamine resins; urea resins; maleimide resins; and silicones. Here, the above plastic substrate may be constituted of only one type of plastic material or may be constituted of two or more types of plastic materials.

Among the above plastic substrates, a substrate excelling in heat resistance, moldability, and mechanical strength is preferably used, and a polyester film (in particular, PET and PEN), a cyclic polyolefin film, a polycarbonate film, a TAC film, or a PMMA film is more preferable.

The plastic substrate may contain another additive as necessary, such as an antioxidant, an ultraviolet absorber, a light-resistant stabilizer, a thermal stabilizer, a crystal nucleating agent, a flame retardant, a flame retardant auxiliary, a filler, a plasticizer, an impact modifier, a reinforcing agent, a dispersant, an antistatic agent, a foaming agent, and an antibacterial agent. Here, one type of the additive can be used alone, or two or more types thereof can be used in combination.

The plastic substrate may have a single layer configuration, or may have a multilayer (laminated) configuration, and the configuration (structure) thereof is not particularly limited. For example, the plastic substrate may be a plastic substrate having a laminated configuration such as a “plastic film/other layer” or “other layer/plastic film/other layer” in which a layer other than the transfer layer according to an embodiment of the present invention (sometimes referred to as an “other layer”) is formed on at least one surface of the plastic film. Examples of the other layer include a hard coat layer other than the hard coat layer constituting the transfer film according to an embodiment of the present invention. Examples of the material constituting the other layer include the plastic materials described above.

Part of all of the plastic substrate may be subjected to a well-known or commonly used surface treatment such as a roughening treatment, adhesion-facilitating treatment, antistatic treatment, sand blast treatment (sand mat treatment), corona discharge treatment, plasma treatment, chemical etching treatment, water mat treatment, flame treatment, acid treatment, alkali treatment, oxidation treatment, ultraviolet irradiation treatment, and silane coupling agent treatment. Here, the plastic substrate may be an unstretched film or a stretched film (such as a uniaxially stretched film and a biaxially stretched film).

The plastic substrate can be produced, for example, by a well-known or commonly used method such as a method in which the plastic material described above is formed into a film shape to form a plastic substrate (plastic film), or a method in which an appropriate layer (such as, for example, the other layers described above) is further formed on the plastic film as necessary, and an appropriate surface treatment is implemented. In addition, a commercially available product can be also used as the plastic substrate.

The thickness of the substrate is not particularly limited and, for example, can be appropriately selected from a range of from 0.01 to 10000 μm, but from perspectives such as moldability, shape following properties, and handling properties, the thickness is preferably from 2 to 250 μm, more preferably from 5 to 100 μm, and even more preferably from 20 to 100 μm.

The release layer of the transfer film according to an embodiment of the present invention is a layer that constitutes at least one surface layer of a substrate in the transfer film according to an embodiment of the present invention, and is a layer that is provided to facilitate detachment of the transfer layer from the substrate. Providing the release layer facilitates reliable and easy transfer of the transfer layer from the transfer film to the transfer target (molded article), and reliable detachment of the substrate sheet.

In the transfer film according to an embodiment of the present invention, the peeling strength of the release layer and the hard coat layer is not particularly limited, but is preferably from 30 to 500 mN/24 mm, more preferably from 40 to 300 mN/24 mm, and even more preferably from 50 to 200 mN/24 mm. When the peeling strength is within this range, the hard coat layer tends to easily detach at the same time as the transfer to the molded article, without detachment of the hard coat layer during normal handling. The peeling strength of the hard coat layer and the release layer according to an embodiment of the present invention can be measured in accordance with JIS Z0237.

Here, the release layer of the transfer film according to an embodiment according to an embodiment of the present invention may be formed on only one surface (one side) of the substrate, or may be formed on both surfaces (both sides) of the substrate.

Furthermore, the release layer of the transfer film according to an embodiment of the present invention may be formed on only a portion of each surface of the substrate, or may be formed over the entirety of each surface thereof.

A well-known release agent can be used, without any particularly restrictions, as a component forming the release layer, and for example, at least one type selected from unsaturated ester-based resins, epoxy-based resins, epoxy-melamine resins, aminoalkyd resins, acrylic resins, melamine-based resins, silicon-based resins, fluororesins, cellulose-based resins, urea resin-based resins, polyolefin resins, paraffin resins, and cycloolefin resins can be used. From the perspective of releasability with the hard coat layer according to an embodiment of the present invention in contact with the release layer of the transfer layer, the release layer is preferably a melamine resin or a cycloolefin resin, and is particularly preferably a cycloolefin copolymer resin (COC resin) such as a 2-norbornene-ethylene copolymer.

As the method for forming the release layer on the substrate surface, a well-known release processing method can be used without particular limitation. For example, the release layer can be formed by dispersing or dissolving the resin in a solvent (for example, an alcohol such as methanol or butanol, an aromatic hydrocarbon such as toluene or xylene, or tetrahydrofuran), coating the mixture using a known coating method such as bar coating, Mayer bar coating, gravure coating, or roll coating, and drying then heating at 80 to 200° C. The thickness of the release layer is not particularly limited, and can typically be selected from a range from 0.01 to 5 m, and preferably from 0.1 to 3.0 μm.

The hard coat layer according to an embodiment of the present invention of the transfer film according to an embodiment of the present invention is a layer that constitutes at least one surface layer of the release layer, and is an uncured layer obtained by drying the curable composition (hard coat agent) according to an embodiment of the present invention, or a semi-cured layer that is partially cured. The semi-cured hard coat layer can be formed by partially advancing curing by subjecting the uncured hard coat layer to irradiation with active energy rays or heating as described above.

The uncured or semi-cured hard coat layer according to an embodiment of the present invention has excellent blocking resistance and low tackiness such that when a user touches the surface using a finger, the resin does not adhere to the finger, and the uncured or semi-cured hard coat layer can be wound and handled in a roll shape.

Here, the hard coat layer according to an embodiment of the present invention of the hard coat film according to an embodiment of the present invention may be formed on only one surface (one side) of the substrate, or may be formed on both surfaces (both sides) of the substrate.

Furthermore, the hard coat layer in the transfer film according to an embodiment of the present invention may be formed on only a portion of each surface of the substrate, or may be formed over the entirety of each surface thereof.

The method of laminating the hard coat layer according to an embodiment of the present invention on the release layer of the transfer film according to an embodiment of the present invention is not particularly limited, and examples include a method in which the curable composition (hard coat agent) according to an embodiment of the present invention is coated to the release layer and dried to form an uncured hard coat layer using a known method, or a method further including irradiating the uncured hard coat layer with active energy rays or heating the uncured hard coat layer to form a semi-cured hard coat layer. A known coating method can be used without limitation as the method for coating the curable composition (hard coat agent) according to an embodiment of the present invention, and examples include bar coater coating, Mayer bar coating, air-knife coating, gravure coating, offset printing, flexographic printing, and screen printing.

The heating temperature when forming the hard coat layer is not particularly limited, but is preferably selected, as appropriate, from a range of from 50 to 200° C. The heating time is not particularly limited, but can be preferably and appropriately selected from a range of from 1 to 60 minutes. The conditions for irradiating the hard coat layer with active energy rays are not particularly limited, and can be appropriately selected from the above-described conditions when forming a cured product.

The thickness of the hard coat layer of the transfer film according to an embodiment of the present invention (the thickness of each hard coat layer for a case in which a hard coat layer according to an embodiment of the present invention is provided on both sides of a substrate) is not particularly limited, but is preferably from 1 to 200 μm, and more preferably from 3 to 150 μm. In particular, the hard coat layer according to an embodiment of the present invention can maintain a high hardness of the surface (for example, a pencil hardness of 5H or greater) even when the hard coat layer is thin (for example, a thickness of 5 μm or less). In addition, even if the hard coat layer is thick (for example, a thickness of 50 μm or greater), defects such as crack generation due to curing shrinkage or the like are unlikely to occur, and therefore the pencil hardness can be significantly increased (for example, the pencil hardness can be set to 9H or greater).

The haze of the hard coat layer of the transfer film of an embodiment of the present invention is not particularly limited, but, in case of the thickness of 50 μm, it is preferably 1.5% or less and more preferably 1.0% or less. In addition, the lower limit of the haze is not particularly limited but is, for example, 0.1%. Setting the haze to particularly 1.0% or less is preferable because, for example, when the transfer film according to an embodiment of the present invention is used as a decorative film, the pattern and design can be vividly transferred. Here, the haze of the hard coat layer according to an embodiment of the present invention can be measured according to JIS K7136.

The total light transmittance of the hard coat layer of the transfer film according to an embodiment of the present invention is not particularly limited, but when the thickness is 50 μm, the total light transmittance is preferably 85% or greater, and more preferably 90% or greater. In addition, the upper limit of the total light transmittance is not particularly limited but is, for example, 99%. Setting the total light transmittance to 85% or greater is preferable because, for example, when the transfer film according to an embodiment of the present invention is used as a decorative film, a pattern or design can be vividly transferred. Here, the total light transmittance of the hard coat layer according to an embodiment of the present invention can be measured according to JIS K7361-1.

The transfer film according to an embodiment of the present invention preferably further includes an anchor coat layer and an adhesive agent layer laminated on the hard coat layer in this order. Furthermore, when the transfer film according to an embodiment of the present invention is used as a decorative film, at least one colored layer is laminated. The lamination position of the colored layer is not particularly limited, but an aspect in which one or more colored layers are laminated between the anchor coat layer and the adhesive agent layer is preferable.

The anchor coat layer of the transfer film according to an embodiment of the present invention is provided to improve adhesion between the hard coat layer and the adhesive agent layer or colored layer. The anchor coat layer is preferably a transparent or semi-transparent layer to vividly transfer the patterns and designs of the colored layer, and one type of resin may be used alone, or a mixture or two or more type may be used, including, for example, heat curing resins such as a phenolic resin, an alkyd resin, a melamine-based resin (for example, methylated melamine resin, butylated melamine resin, methyl-etherified melamine resin, butyl-etherified melamine resin, methylbutyl mixed etherified melamine resin), epoxy resins (for example, bisphenol A epoxy resins, bisphenol F epoxy resins, multifunctional epoxy resins, flexible epoxy resins, brominated epoxy resins, glycidyl ester epoxy resins, polymeric epoxy resins, biphenyl epoxy resins), urea resins, unsaturated polyester resins, urethane-based resins [for example, urethane resins that can be obtained through a reaction between a polyisocyanate compound (O═C═N—R—N═C═O) having two or more isocyanate groups and a polyol compound (HO—R′—OH) having two or more hydroxyl groups, a compound having an active hydrogen (—NH₂, —NH, —CONH— or the like) such as a polyamine (H₂N—R″—NH₂), or water], a thermosetting polyimide, and a silicone resin, and thermoplastic resins such as a vinyl chloride-vinyl acetate copolymer resin, an acrylic resin (for example, acrylic polyol resins), a rubber chloride, polyamide resin, a nitrocellulose resin, and cyclic polyolefin resin. However, epoxy resins are preferable.

The resin for the anchor coat according to an embodiment of the present invention may further contain, as the other optional components, commonly used additives such as waxes, silica, plasticizers, leveling agents, surfactants, dispersants, antifoaming agents, ultraviolet absorbers, ultraviolet light stabilizers, and antioxidants, within a range that does not impair the effects of the present invention. One type alone or two or more types of these additives in combination can be used.

The anchor coat layer can be formed by using a known coating method such as bar coating, Mayer bar coating, gravure coating, or roll coating to coat the hard coat layer according to an embodiment of the present invention with a coating solution in which the resin is dissolved in a solvent, and then drying the coating, and heating as necessary.

The temperature when heating is used to form the anchor coat layer is not particularly limited, but is preferably selected, as appropriate, from 50 to 200° C. The heating time is not particularly limited, but can be preferably selected, as appropriate, from 10 seconds to 60 minutes.

The thickness of the anchor coat layer is normally approximately from 0.1 to 20 μm, and preferably is in a range from 0.5 to 5 μm.

The anchor coat layer according to an embodiment of the present invention may be formed using a commercially available anchor coating agent. Examples of commercially available anchor coat agents include K468HP Anchor (epoxy resin-based anchor coating agent available from Toyo Ink Co., Ltd.), and TM-VMAC (acrylic polyol resin-based anchor coating agent available from Dainichiseika Color & Chemicals Mfg. Co., Ltd.).

The adhesive agent layer in the transfer film according to an embodiment of the present invention is provided for transferring a transfer layer (including a hard coat layer, an optionally laminated anchor coat layer, and a colored layer) to a molded article with good adhesion. Examples of the adhesive agent layer include a heat-sensitive adhesive and a pressure-sensitive adhesive, but in the present invention, the adhesive agent layer is preferably a heat sealing layer that exhibits adhesion to a molded article by heating and pressing as necessary. As the resin used in the adhesive agent layer, one type of resin may be used alone, or a mixture of two or more types may be used, and examples of the resin include acrylic resins, vinyl chloride resins, vinyl acetate resins, vinyl chloride-vinyl acetate copolymer resins, styrene-acrylic copolymer resins, polyester resins, and polyamide resins. However, acrylic resins and vinyl chloride-vinyl acetate copolymer resins are particularly preferable.

The acrylic resin used in the adhesive agent layer according to an embodiment of the present invention is not particularly limited, and examples thereof include acrylic resins such as polymethyl (meth)acrylate, polyethyl (meth)acrylate, polybutyl (meth)acrylate, methyl (meth)acrylate-butyl (meth)acrylate copolymers, and methyl (meth)acrylate-styrene copolymers, and acrylic resins modified by fluorine. One type of these resins may be used alone, or a mixture of two or more types can be used. In addition, an acrylic polyol obtained by copolymerizing an alkyl (meth)acrylate such as methyl (meth)acrylate, ethyl (meth)acrylate, butyl (meth)acrylate, 2-ethylhexyl (meth)acrylate, or octyl (meth)acrylate, with a (meth)acrylate having a hydroxyl group in the molecule such as 2-hydroxyethyl (meth)acrylate, 2-hydroxybutyl (meth)acrylate, or 2-hydroxy-3-phenoxypropyl (meth) acrylate can also be used. As the vinyl chloride-vinyl acetate copolymer resin, typically one having a vinyl acetate content of approximately 5 to 20 mass % and an average degree of polymerization of approximately 350 to 900 is used. If necessary, the vinyl chloride-vinyl acetate copolymer resin may be further copolymerized with a carboxylic acid such as maleic acid or fumaric acid. In addition, as appropriate, another resin such as, for example, a thermoplastic polyester resin, a thermoplastic urethane resin, or a chlorinated polyolefin-based resin such as a chlorinated polyethylene, and a chlorinated polypropylene may be mixed, as necessary, as a sub-component resin.

The adhesive agent layer can be formed by making one or more types of the resins described above into a material that is in a coatable form such as a solution or emulsion, and coating the material using a known coating method such as bar coating, Mayer bar coating, gravure coating, or roll coating, and then drying the coating, and heating as necessary.

The temperature when heating is used to form the adhesive agent layer is not particularly limited, but is preferably selected, as appropriate, from 50 to 200° C. The heating time is not particularly limited, but can be preferably selected, as appropriate, from 10 seconds to 60 minutes.

From the perspective of being able to efficiently transfer the transfer film to the molded article with good adhesion, the thickness of the adhesive agent layer is preferably approximately 0.1 to 10 μm, and more preferably from 0.5 to 5 μm.

The adhesive agent layer may also be blended with an organic ultraviolet absorber such as a benzophenone-based compound, a benzotriazole-based compound, an oxalic anilide-based compound, a cyanoacrylate-based compound, or a salicylate-based compound, and with an additive of microparticles having an inorganic ultraviolet absorbing function like that of an oxide of zinc, titanium, cerium, tin or iron. Furthermore, as additives, coloring pigments, white pigments, extender pigments, fillers, antistatic agents, antioxidants, and fluorescent brighteners can be appropriately used as necessary.

Commercially available products may be used as the adhesive according to an embodiment of the present invention. Examples of commercially available adhesives include K588HP Adhesive Gloss A varnish (vinyl chloride-vinyl acetate copolymer resin adhesive available from Toyo Ink Co., Ltd.), and PSHP780 (acrylic resin adhesive available from Toyo Ink Co., Ltd.).

The colored layer in the transfer film according to an embodiment of the present invention is provided for a case in which the colored layer is used as a decorative film for transferring a design layer and/or a concealing layer to a molded article. Here, the design layer is a layer that is provided to express patterns and characters along with a pattern-shaped design, and the concealing layer is a layer that is normally a full surface solid layer, and is provided to conceal coloring of an injection resin or the like. The concealing layer may form a decorative layer by itself for cases other than a case where the concealing layer is provided inside the design layer to enhance the design of the design layer.

The design layer according to an embodiment of the present invention is a layer that is provided to express patterns and characters along with a pattern-shaped design. The design of the design layer is optional, and examples thereof include designs containing wood grain textures, stone textures, cloth texture, sand textures, geometric patterns, and characters.

The colored layer is typically formed on the hard coat layer or anchor coat layer with a printing ink through a known printing method such as gravure printing, offset printing, silk screen printing, transfer printing from a transfer sheet, sublimation transfer printing, or ink jet printing, and can be formed between the hard coat layer and the adhesive agent layer, or between the anchor coat layer and the adhesive agent layer. From the perspective of design performance, the thickness of the colored layer is preferably from 3 to 40 μm, and more preferably from 10 to 30 μm.

Preferable examples of the binder resin of the printing ink used to form the colored layer include polyester resins, polyurethane resins, acrylic resins, vinyl acetate resins, vinyl chloride-vinyl acetate copolymer resins, and cellulose-based resins. However, use of an acrylic resin by itself or a mixture of an acrylic resin and a vinyl chloride-vinyl acetate copolymer resin as a main component is preferable. Among these, when an acrylic resin, a vinyl chloride-vinyl acetate copolymer resin, or another acrylic resin are mixed, the suitability for printing and moldability is further improved, which is preferable. Examples of the acrylic resin include acrylic resins such as polymethyl (meth)acrylate, polyethyl (meth)acrylate, polybutyl (meth)acrylate, methyl (meth)acrylate-butyl (meth)acrylate copolymers, and methyl (meth)acrylate-styrene copolymers, and acrylic resins modified by fluorine. One type of these resins may be used alone, or a mixture of two or more types can be used. In addition, an acrylic polyol obtained by copolymerizing an alkyl (meth)acrylate such as methyl (meth)acrylate, ethyl (meth)acrylate, butyl (meth)acrylate, 2-ethylhexyl (meth)acrylate, or octyl (meth)acrylate, with a (meth)acrylate having a hydroxyl group in the molecule such as 2-hydroxyethyl (meth)acrylate, 2-hydroxybutyl (meth)acrylate, or 2-hydroxy-3-phenoxypropyl (meth) acrylate can also be used. As the vinyl chloride-vinyl acetate copolymer resin, typically one having a vinyl acetate content of approximately from 5 to 20 mass % and an average degree of polymerization of approximately from 350 to 900 is used. As necessary, the vinyl chloride-vinyl acetate copolymer resin may be further copolymerized with a carboxylic acid such as maleic acid or fumaric acid. The mixing ratio of the acrylic resin and the vinyl chloride-vinyl acetate copolymer resin is approximately (acrylic resin)/(vinyl chloride-vinyl acetate copolymer resin) of 1/9 to 9/1 (mass ratio). In addition, as appropriate, another resin such as, for example, a thermoplastic polyester resin, a thermoplastic urethane resin, a chlorinated polyethylene, or a chlorinated polyolefin-based resin such as a chlorinated polypropylene may be mixed, as necessary, as a sub-component resin.

As the coloring agent used in the colored layer according to the present invention, one type may be used alone or two or more types may be mixed and used, and examples include metallic pigments containing flake-shaped foil powder of a metal, alloy, or metal compound of aluminum, chromium, nickel, tin, titanium, iron phosphide, copper, gold, silver, or brass; mica iron oxide, titanium dioxide coated mica, titanium dioxide coated bismuth oxychloride, bismuth oxychloride, titanium dioxide coated talc, fish scale foil, colored titanium dioxide coated mica, basic lead carbonate, and other such pearlescent (pearl) pigments containing a foil powder; strontium aluminate, calcium aluminate, barium aluminate, zinc sulfide, calcium sulfide, and other such fluorescent pigments; titanium dioxide, zinc oxide, antimony trioxide, and other such white inorganic pigments; zinc oxide, red iron oxide, crimson, ultramarine blue, cobalt blue, titanium yellow, chrome yellow, carbon black, and other such inorganic pigments; isoindolinone yellow, Hansa yellow A, quinacridone red, permanent red 4R, phthalocyanine blue, indanthrene blue RS, aniline black, and other such organic pigments (also including dyes).

Such a colored layer is provided to impart a design property to the transfer film according to an embodiment of the present invention, but a metal thin film layer or the like may also be formed for the purpose of improving design performance. The metal thin film layer can be formed using a metal such as aluminum, chromium, gold, silver, or copper with a method such as vacuum deposition or sputtering. The metal thin film layer may be provided on the entire surface or may be partially provided in a pattern shape.

In addition to the aforementioned components, an additive such as a sedimentation inhibitor, a curing catalyst, an ultraviolet absorber, an antioxidant, a leveling agent, a thickening agent, an antifoaming agent, and a lubricant can be added, as appropriate, to the printing ink used to form the colored layer. The printing ink is provided in a form in which the aforementioned components are typically dissolved or dispersed in a solvent. The solvent may be a solvent that dissolves or disperses the binder resin, and an organic solvent and/or water can be used. Examples of organic solvents include hydrocarbons such as toluene and xylene; ketones such as acetone and methyl ethyl ketone; esters such as ethyl acetate, cellosolve acetate, and butyl cellosolve acetate; and alcohols.

In addition to the substrate, the release layer, the hard coat layer, the anchor coat layer, the adhesive agent layer, and the colored layer described above, the transfer film according to an embodiment of the present invention may also include, as desired, a low reflection layer, an antistatic layer, an ultraviolet absorbing layer, a near infrared ray shielding layer, and an electromagnetic wave absorbing layer, laminated in any order.

The thickness of the transfer film according to an embodiment of the present invention is not particularly limited, and can be appropriately selected from a range from 1 to 10000 μm, but from the perspectives of moldability, shape following properties, and handling properties, the thickness thereof is preferably from 2 to 250 μm, more preferably from 5 to 150 μm, and even more preferably from 25 to 150 μm.

The hard coat layer of the transfer film according to an embodiment of the present invention is tack-free, excels in blocking resistance, and can be wound and handled in a roll shape, and therefore the hard coat layer can be suitably used as a transfer film for in-mold injection molding. For example, the transfer film according to an embodiment of the present invention is continuously conveyed in a mold including a fixed mold and a movable mold using a conveyance roll or the like, and after the substrate film side contacts the fixed mold surface and appropriate position adjustments have been made, the movable mold moves to clamp the mold. Next, a thermoplastic resin that has been melted by heat in advance is injected at a high temperature and high pressure into the mold from the transfer layer side of the transfer film to thereby fill the mold, and then quenched, after which the mold is opened, and a molded article (in-mold molded article) to which the hard coat layer according to an embodiment of the present invention is transferred to the outermost surface can then be removed.

When the hard coat layer according to an embodiment of the present invention of the molded article is uncured or semi-cured, the hard coat layer may be irradiated with active energy rays and/or heated to cure the hard coat layer. The conditions when subjecting the hard coat layer to irradiation with active energy rays and/or heating are not particularly limited, and for example, can be appropriately selected from the above-described conditions when forming the cured product.

The cured hard coat layer according to an embodiment of the present invention is formed on the outermost surface of the molded product after the transfer layer of the transfer film according to an embodiment of the present invention has been transferred to the molded article, and therefore the pencil hardness of the molded article surface can be made very high, and is preferably 5H or greater, and more preferably 6H or greater. Here, the pencil hardness can be evaluated according to the method described in JIS K5600-5-4.

Molded articles (in-mold molded articles) produced by in-mold injection molding using the transfer film according to an embodiment of the present invention have very high surface hardness, and designs and patterns are vividly transferred, and therefore the present invention can be preferably used in any molded article where such characteristics are required. The transfer film according to an embodiment of the present invention can be suitably used in a variety of exterior molded articles that require high surface hardness, scratch resistance, design properties, and durability, including, for example, automotive interior products such as dashboards, and housings for consumer electronics.

### Hard Coat Film

The hard coat film according to an embodiment of the present invention is a film having a substrate and a hard coat layer formed on at least one surface of the substrate, wherein the hard coat layer is a hard coat layer that is formed from the curable composition according to an embodiment of the present invention (hard coat layer forming curable composition) (cured product layer of the curable composition according to an embodiment of the present invention).

Here, the hard coat layer of the hard coat film according to an embodiment of the present invention may be formed on only one surface (one side) of the substrate, or may be formed on both surfaces (both sides) of the substrate.

Furthermore, the hard coat layer of the hard coat film according to an embodiment of the present invention may be formed on only a portion of each surface of the substrate, or may be formed over the entirety of each surface thereof.

The substrate of the hard coat film according to an embodiment of the present invention is a substrate of a hard coat film, and refers to a portion constituting a part other than the hard coat layer according to an embodiment of the present invention. The substrate is not particularly limited, and a well-known or commonly used substrate can be used, such as a plastic substrate, a metal substrate, a ceramic substrate, a semiconductor substrate, a glass substrate, a paper substrate, a wood substrate (wooden substrate), and a substrate having a surface that is a coated surface. Among these, a plastic substrate (a substrate constituted of a plastic material) is preferred.

The plastic material constituting the plastic substrate is not particularly limited. Examples thereof include various plastic materials, such as polyesters, such as polyethylene terephthalate (PET) and polyethylene naphthalate (PEN); polyimides; polycarbonates; polyamides; polyacetals; polyphenylene oxides; polyphenylene sulfides; polyethersulfones; polyetheretherketones; cyclic polyolefins, such as homopolymers of norbornene-based monomers (such as addition polymers and ring-opened polymers), copolymers of a norbornene-based monomer and an olefin-based monomer (such as cyclic olefin copolymers, such as addition polymers and ring-opened polymers), such as a copolymer of norbornene and ethylene, and derivatives thereof; vinyl-based polymers (for example, acrylic resins, such as polymethyl methacrylates (PMMA), polystyrenes, polyvinyl chlorides, and acrylonitrile-styrene-butadiene resins (ABS resins)); vinylidene polymers (for example, such as polyvinylidene chlorides); cellulose resins, such as triacetyl cellulose (TAC); epoxy resins; phenolic resins; melamine resins; urea resins; maleimide resins; and silicones. Here, the above plastic substrate may be constituted of only one type of plastic material or may be constituted of two or more types of plastic materials.

Among the above plastic substrates, when the object is to obtain a hard coat film having excellent transparency as the hard coat film according to an embodiment of the present invention, a substrate having excellent transparency (transparent substrate) is preferably used, and more preferably a polyester film (in particular, PET and PEN), a cyclic polyolefin film, a polycarbonate film, a TAC film, or a PMMA film is used.

The plastic substrate may contain an additional additive as necessary, such as an antioxidant, an ultraviolet absorber, a light-resistant stabilizer, a thermal stabilizer, a crystal nucleating agent, a flame retardant, a flame retardant auxiliary, a filler, a plasticizer, an impact modifier, a reinforcing agent, a dispersant, an antistatic agent, a foaming agent, and an antibacterial agent. Here, one type of the additive can be used alone, or two or more types thereof can be used in combination.

The plastic substrate may have a single layer configuration, or may have a multilayer (laminated) configuration, and the configuration (structure) thereof is not particularly limited. For example, the plastic substrate may be a plastic substrate having a laminated configuration such as a “plastic film/other layer” or “other layer/plastic film/other layer” in which a layer other than the hard coat layer according to an embodiment of the present invention (sometimes referred to as an “other layer”) is formed on at least one surface of the plastic film. Examples of the other layer include a hard coat layer other than the hard coat layer according to an embodiment of the present invention. Examples of the material constituting the other layer include the plastic materials described above.

A well known or commonly used surface treatment such as roughening treatment, adhesion-facilitating treatment, antistatic treatment, sand blast treatment (sand mat treatment), corona discharge treatment, plasma treatment, chemical etching treatment, water mat treatment, flame treatment, acid treatment, alkali treatment, oxidation treatment, ultraviolet irradiation treatment, and silane coupling agent treatment may be applied to part or all of the surface of the plastic substrate. Here, the plastic substrate may be an unstretched film or a stretched film (such as a uniaxially stretched film and a biaxially stretched film).

The plastic substrate can be produced, for example, by a well-known or commonly used method such as a method in which the plastic material described above is formed into a film shape to form a plastic substrate (plastic film), or a method in which an appropriate layer (such as, for example, the other layers described above) is further formed on the plastic film as necessary, and an appropriate surface treatment is implemented. In addition, a commercially available product can be also used as the plastic substrate.

The thickness of the substrate is not particularly limited, but can be appropriately selected from a range of from 0.01 to 10000 μm, for example.

The hard coat layer according to an embodiment of the present invention of the hard coat film according to an embodiment of the present invention is a layer that constitutes at least one surface layer in the hard coat film according to an embodiment of the present invention, and is a layer (cured product layer) formed from a cured product (resin cured product) obtained by curing the curable composition (hard coat layer forming curable composition) according to an embodiment of the present invention.

The thickness of the hard coat layer according to an embodiment of the present invention (the thickness of each hard coat layer for a case in which a hard coat layer according to an embodiment of the present invention is provided on both sides of a substrate) is not particularly limited, but is preferably from 1 to 200 μm, and more preferably from 3 to 150 μm. In particular, the hard coat layer according to an embodiment of the present invention can maintain a high hardness of the surface (for example, a pencil hardness of H or greater) even when the hard coat layer is thin (for example, a thickness of 5 μm or less). In addition, even if the hard coat layer is thick (for example, a thickness of 50 μm or greater), defects such as crack generation due to curing shrinkage or the like are unlikely to occur, and therefore the pencil hardness can be significantly increased (for example, the pencil hardness can be set to 9H or greater).

The haze of the hard coat layer according to an embodiment of the present invention is not particularly limited, and when the thickness is 50 μm, the haze is preferably 1.5% or less, and more preferably 1.0% or less. In addition, the lower limit of the haze is not particularly limited but is, for example, 0.1%. The laminate with a haze particularly of 1.0% or less tends to be suitable for use, for example, in applications requiring very high transparency (for example, such as a surface protection sheet of a display of a touch panel, or the like). Here, the haze of the hard coat layer according to an embodiment of the present invention can be measured according to JIS K7136.

The total light transmittance of the hard coat layer according to an embodiment of the present invention is not particularly limited, but when the thickness is 50 μm, the total light transmittance is preferably 85% or greater and more preferably 90% or greater. In addition, the upper limit of the total light transmittance is not particularly limited but is, for example, 99%. When the total light transmittance is set to 85% or greater, for example, the present invention tends to be suitable for use, for example, in applications requiring very high transparency (for example, as a surface protection sheet of a display of a touch panel). Here, the total light transmittance of the hard coat layer according to an embodiment of the present invention can be measured according to JIS K7361-1.

The hard coat film according to an embodiment of the present invention may further have a surface protection film on the surface of the hard coat layer according to an embodiment of the present invention. Because the hard coat film according to an embodiment of the present invention has a surface protection film, the punching processability of the hard coat film tends to be further improved. When a surface protection film is provided in this manner, for example, even if the hardness of the hard coat layer is extremely high and detachment from the substrate or cracking readily occur during the punching process, punching can be performed using a Thomson blade without causing such problems.

The surface protection film is not particularly limited, and a well-known or commonly used surface protection film can be used. For example, a film having a tacky adhesive agent layer on the surface of the plastic film can be used. Examples of the plastic film include plastic films formed from plastic materials such as polyesters (polyethylene terephthalate, polyethylene naphthalate), polyolefins (polyethylene, polypropylene, cyclic polyolefins), polystyrenes, acrylic resins, polycarbonates, epoxy resins, fluororesins, silicone resins, diacetate resins, triacetate resins, polyarylates, polyvinyl chlorides, polysulfones, polyethersulfones, polyether ether imides, polyimides, and polyamides. Examples of the tacky adhesive agent layer include a tacky adhesive agent layer formed from one or more types of well-known and commonly used tacky adhesives such as acrylic tacky adhesives, natural rubber-based tacky adhesives, synthetic rubber-based tacky adhesives, ethylene-vinyl acetate copolymer-based tacky adhesives, ethylene-(meth)acrylate copolymer-based tacky adhesives, styrene-isoprene block copolymer-based tacky adhesives, and styrene-butadiene block copolymer-based tacky adhesives. Various additives (for example, antistatic agents, and slip agents) may be included in the tacky adhesive agent layer. Note that the plastic film and the tacky adhesive agent layer may each have a single layer configuration or may have a multilayer (multiple layer) configuration. In addition, the thickness of the surface protection film is not particularly limited, and can be appropriately selected.

As the surface protection film, commercially available products can be procured from the marketplace including, for example, product of the “Sunytect” series (available from Sun A. Kaken Co., Ltd.), product of the “E-MASK” series (available from Nitto Denko Corporation), product of the “Mastack” series (available from Fujimori Kogyo Co., Ltd.), product of the “Hitalex” series (available from Hitachi Chemical Co., Ltd.), and product of the “Alphan” series (available from Oji F-Tex Co., Ltd.).

The hard coat film according to an embodiment of the present invention can be produced according to a well-known or commonly used method for producing a hard coat film. The production method thereof is not particularly limited, and the hard coat film according to an embodiment of the present invention can be produced, for example, by coating the curable composition (hard coat layer forming curable composition) onto at least one surface of the substrate, and if necessary, removing the solvent through drying, and then curing the curable composition (curable composition layer). The conditions for curing the curable composition are not particularly limited, and for example, can be appropriately selected from the above-described conditions when forming the cured product.

In particular, the hard coat layer according to an embodiment of the present invention of the hard coat film according to an embodiment of the present invention is a hard coat layer formed from the curable composition (hard coat layer forming curable composition) according to an embodiment of the present invention capable of forming a cured product having excellent flexibility and processability. Therefore, the hard coat film according to an embodiment of the present invention can be produced with a roll-to-roll process. Production of the hard coat film according to an embodiment of the present invention by a roll-to-roll process can significantly increase the productivity thereof. The method for producing the hard coat film according to an embodiment of the present invention by a roll-to-roll process is not particularly limited, and a well-known or commonly used production method by a roll-to-roll process can be adopted. Examples of the method thereof include a method that includes the following as essential steps: feeding out a substrate wound in a roll shape (step A); coating the curable composition according to an embodiment of the present invention (hard coat layer forming curable composition) to at least one surface of the substrate that was fed out, and then removing, if necessary, the solvent through drying, followed by curing the curable composition (curable composition layer) to form a hard coat layer according to an embodiment of the present invention (step B); and subsequently winding the obtained hard coat film onto a roll once again (step C); wherein these steps (steps A to C) are performed continuously. In addition, the method may also include steps in addition to steps A to C.

The thickness of the hard coat film according to an embodiment of the present invention is not particularly limited, and can be appropriately selected from a range from 1 to 10000 μm.

The pencil hardness of the hard coat layer surface of the hard coat film according to an embodiment of the present invention is not particularly limited, but is preferably H or greater, more preferably 2H or greater, and even more preferably 6H or greater. Here, the pencil hardness can be evaluated according to the method described in JIS K5600-5-4.

The haze of the hard coat film according to an embodiment of the present invention is not particularly limited but is preferably 1.5% or less and more preferably 1.0% or less. In addition, the lower limit of the haze is not particularly limited but is, for example, 0.1%. The laminate with a haze particularly of 1.0% or less tends to be suitable for use, for example, in applications requiring very high transparency (for example, such as a surface protection sheet of a display of a touch panel, or the like). The haze of the hard coat film according to an embodiment of the present invention can be easily controlled to the above range, for example, by using the transparent substrate described above as the substrate. Here, the haze can be measured according to JIS K7136.

The total light transmittance of the hard coat film according to an embodiment of the present invention is not particularly limited but is preferably 85% or greater and more preferably 90% or greater. In addition, the upper limit of the total light transmittance is not particularly limited but is, for example, 99%. When the total light transmittance is set to 90% or greater, for example, the present invention tends to be suitable for use, for example, in applications requiring very high transparency (for example, as a surface protection sheet of a display of a touch panel). The total light transmittance of the hard coat film according to an embodiment of the present invention can be easily controlled to the above range, for example, by using the transparent substrate described above as the substrate. Here, the total light transmittance can be measured according to JIS K7361-1.

The hard coat film according to an embodiment of the present invention has flexibility while maintaining high hardness and high heat resistance, and can be produced and processed with a roll-to-roll process, and therefore has a high level of quality and excellent productivity. In particular, when a surface protection film is provided on the surface of the hard coat layer according to an embodiment of the present invention, punching processability is also excellent. Therefore, the present invention can be preferably used for any application that requires such properties. The hard coat film according to an embodiment of the present invention can be used, for example, as a surface protection film on various products, and as a surface protection film for a member or component of various products, and can also be used as a constituent material for various products or for members or components thereof. Examples of the above products include display devices, such as liquid crystal displays and organic EL displays; input devices, such as touch panels; solar cells; various consumer electronics; various electrical and electronic products; various electrical and electronic products of portable electronic terminals (for example, gaming devices, personal computers, tablets, smartphones, and mobile phones); and various optical devices. Examples of aspects in which the hard coat film according to an embodiment of the present invention is used as a constituent material for various products or for members or components thereof include aspects in which the hard coat film is used in a laminate made from the hard coat film and a transparent conductive film for a touch panel.

### EXAMPLES

Hereinafter, the present invention is described in more detail based on examples, but the present invention is not limited by these examples. Molecular weight of a product was measured with an Alliance HPLC system 2695 (available from Waters), a Refractive Index Detector 2414 (available from Waters), columns of Tskgel GMH_{HR}-M×2 (available from Tosoh Corporation), a guard column of Tskgel guard column H_{HR}L (available from Tosoh Corporation), a column oven of COLUMN HEATER U-620 (available from Sugai), a solvent of THF, and a measurement condition of 40° C. In addition, the ratio of T2 form and T3 form [T3 form/T2 form] in the product was measured by ²⁹Si-NMR spectrum measurement with JEOL ECA500 (500 MHz).

### Production Example 1: Production of an Intermediate Epoxy Group-Containing Polyorganosilsesquioxane

277.2 mmol (68.30 g) of 2-(3,4-epoxycyclohexyl)ethyltrimethoxysilane, 3.0 mmol (0.56 g) of phenyltrimethoxysilane, and 275.4 g of acetone were charged under a nitrogen stream into a 1000 mL flask (reaction vessel) equipped with a thermometer, a stirrer, a reflux condenser, and a nitrogen inlet tube, and the temperature was raised to 50° C. To the mixture thus obtained, 7.74 g of a 5% potassium carbonate aqueous solution (2.8 mmol as potassium carbonate) was added over 5 minutes, after which 2800.0 mmol (50.40 g) of water was added over 20 minutes. Here, no significant temperature increase occurred during the additions. Subsequently, a polycondensation reaction was performed under a nitrogen stream for 5 hours while maintaining the temperature at 50° C.

Next, the reaction solution was cooled, and simultaneous thereto, 137.70 g of methyl isobutyl ketone and 100.60 g of a 5% saline solution were added thereto. The solution was transferred to a 1 L separation funnel, and then 137.70 g of methyl isobutyl ketone was again added, and rinsing with water was performed. After separation, the water layer was removed, and rinsing with water was performed until the lower layer liquid became neutral. The upper layer liquid was then fractioned, after which the solvent was distilled away from the upper layer liquid under conditions of 1 mmHg and 40° C., and 75.18 g of a colorless, transparent liquid product (intermediate epoxy group-containing polyorganosilsesquioxane) containing 25.04 wt. % of methyl isobutyl ketone was obtained.

When the product was analyzed, the number average molecular weight was found to be 2235, and the molecular weight dispersity was 1.54. A ratio of T2 forms and T3 forms [T3 forms/T2 forms] calculated from the ²⁹Si-NMR spectrum of the product was 11.9.

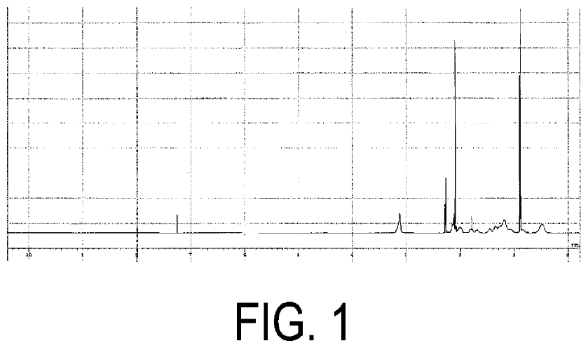

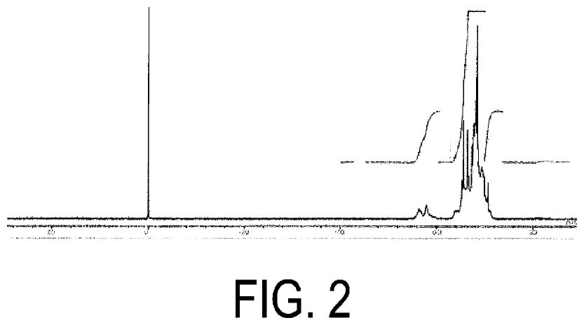

A ¹H-NMR chart of the resulting intermediate epoxy group-containing polyorganosilsesquioxane is illustrated in FIG. 1, and a ²⁹Si-NMR chart thereof is illustrated in FIG. 2.

### Example 1: Production of an Epoxy Group-Containing Polyorganosilsesquioxane According to an Embodiment of the Present Invention (1)

A mixture (75 g) containing the intermediate epoxy group-containing polyorganosilsesquioxane obtained in Production Example 1 was charged under a nitrogen stream into a 1000 mL flask (reaction vessel) equipped with a thermometer, a stirring device, a reflux condenser, and a nitrogen inlet tube. Next, 100 ppm (5.6 mg) of potassium hydroxide and 2000 ppm (112 mg) of water were added to a net content amount (56.2 g) of the intermediate epoxy group-containing polyorganosilsesquioxane, and the mixture was heated for 18 hours at 80° C., and then the mixture was sampled, and the molecular weight was measured. It was found that the number average molecular weight Mn had increased to 6000. Next, the mixture was cooled to room temperature, 300 mL of methyl isobutyl ketone was added, and 300 mL of water was added, and when the alkali component was removed through repeated rinsing with water, and the mixture was concentrated, 74.5 g of a colorless, transparent, liquid product (epoxy-group containing polyorganosilsesquioxane 1 according to an embodiment of the present invention) containing 25 wt. % of methyl isobutyl ketone was obtained.

When the product was analyzed, the number average molecular weight was found to be 6176, and the molecular weight dispersity was 2.31. A ratio of T2 forms and T3 forms [T3 forms/T2 forms] calculated from the ²⁹Si-NMR spectrum of the product was 50.2.

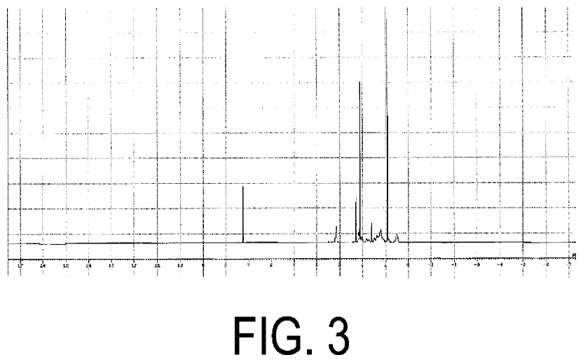

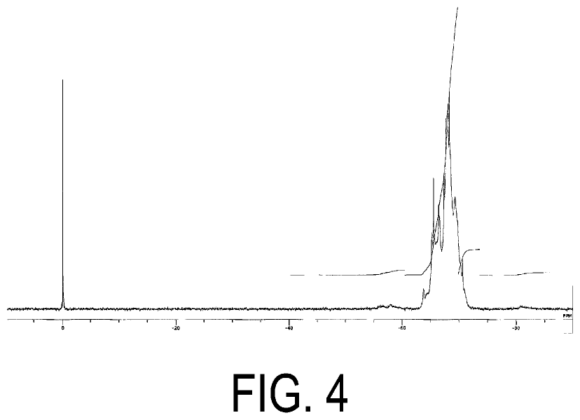

A ¹H-NMR chart of the resulting epoxy group-containing polyorganosilsesquioxane 1 is illustrated in FIG. 3, and a ²⁹Si-NMR chart thereof is illustrated in FIG. 4.

### Example 2: Production of an Epoxy Group-Containing Polyorganosilsesquioxane According to an Embodiment of the Present Invention (2)

A mixture (75 g) containing an intermediate epoxy group-containing polyorganosilsesquioxane obtained with the same method as that of Production Example 1 was charged under a nitrogen stream into a 1000 mL flask (reaction vessel) equipped with a thermometer, a stirring device, a reflux condenser, and a nitrogen inlet tube. Next, 100 ppm (5.6 mg) of potassium carbonate and 2000 ppm (112 mg) of water were added to a net content amount (56.2 g) of the intermediate epoxy group-containing polyorganosilsesquioxane, and the mixture was heated for 18 hours at 80° C., and then the mixture was sampled, and the molecular weight was measured. It was found that the number average molecular weight Mn had increased to 4800. Next, the mixture was cooled to room temperature, 300 mL of methyl isobutyl ketone was added, and 300 mL of water was added, and when the alkali component was removed through repeated rinsing with water, and the mixture was concentrated, 74.5 g of a colorless, transparent, liquid product (epoxy-group containing polyorganosilsesquioxane 2 according to an embodiment of the present invention) containing 25 wt. % of methyl isobutyl ketone was obtained.

### Example 3: Production of an Epoxy Group-Containing Polyorganosilsesquioxane According to an Embodiment of the Present Invention (3)

A mixture (75 g) containing the intermediate epoxy group-containing polyorganosilsesquioxane obtained with the same method as that of Production Example 1 was charged under a nitrogen stream into a 1000 mL flask (reaction vessel) equipped with a thermometer, a stirring device, a reflux condenser, and a nitrogen inlet tube. Next, 100 ppm (5.6 mg) of potassium carbonate and 2000 ppm (112 mg) of water were added to a net content amount (56.2 g) of the intermediate epoxy group-containing polyorganosilsesquioxane, and the mixture was heated for 3 hours at 80° C., and then the mixture was sampled, and the molecular weight was measured. It was found that the number average molecular weight Mn had increased to 3500. Next, the mixture was cooled to room temperature, 300 mL of methyl isobutyl ketone was added, and 300 mL of water was added, and when the alkali component was removed through repeated rinsing with water, and the mixture was concentrated, 74.5 g of a colorless, transparent, liquid product (epoxy-group containing polyorganosilsesquioxane 3 according to an embodiment of the present invention) containing 25 wt. % of methyl isobutyl ketone was obtained.

When the product was analyzed, the number average molecular weight was found to be 3500, and the molecular weight dispersity was 2.14. A ratio of T2 forms and T3 forms [T3 forms/T2 forms] calculated from the ²⁹Si-NMR spectrum of the product was 21.

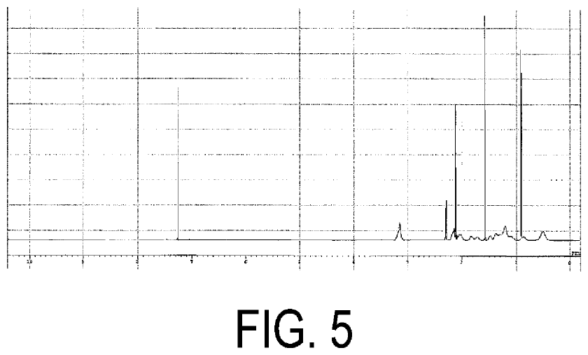

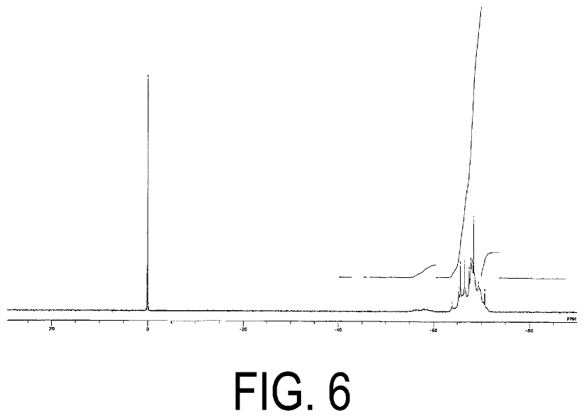

A ¹H-NMR chart of the resulting epoxy group-containing polyorganosilsesquioxane 3 is illustrated in FIG. 5, and a ²⁹Si-NMR chart thereof is illustrated in FIG. 6.

### Production Example 2: Production of an Intermediate Acrylic Group-Containing Polyorganosilsesquioxane

370 mmol (80 g) of 3-(acryloxy)propyltrimethoxysilane, and 320 g of acetone were charged under a nitrogen stream into a 1000 mL flask (reaction vessel) equipped with a thermometer, a stirrer, a reflux condenser, and a nitrogen inlet tube, and the temperature was raised to 50° C. To the mixture thus obtained, 10.144 g of a 5% potassium carbonate aqueous solution (3.67 mmol as potassium carbonate) was added over 5 minutes, after which 3670.0 mmol (66.08 g) of water was added over 20 minutes. Here, no significant temperature increase occurred during the additions. Subsequently, a polycondensation reaction was performed under a nitrogen stream for 2 hours while maintaining the temperature at 50° C.

Next, the reaction solution was cooled, and simultaneous thereto, 160 g of methyl isobutyl ketone and 99.056 g of a 5% saline solution were added thereto. The solution was transferred to a 1 L separation funnel, and then 160 g of methyl isobutyl ketone was again added, and rinsing with water was performed. After separation, the water layer was removed, and rinsing with water was performed until the lower layer liquid became neutral. The upper layer liquid was then fractioned, after which the solvent was distilled away from the upper layer liquid under conditions of 1 mmHg and 40° C., and 71 g of a colorless, transparent liquid product (intermediate acrylic group-containing polyorganosilsesquioxane) containing 22.5 wt. % of methyl isobutyl ketone was obtained.

When the product was analyzed, the number average molecular weight was found to be 2051, and the molecular weight dispersity was 1.29. A ratio of T2 forms and T3 forms [T3 forms/T2 forms] calculated from the ²⁹Si-NMR spectrum of the product was 13.4.

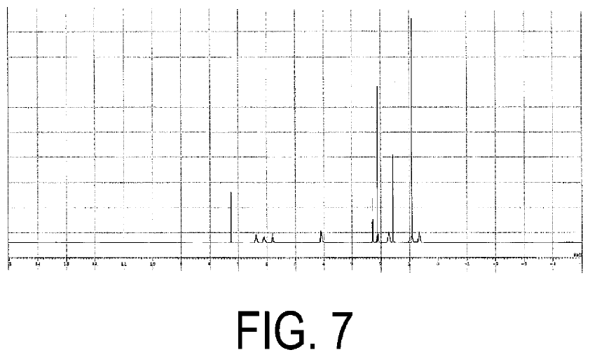

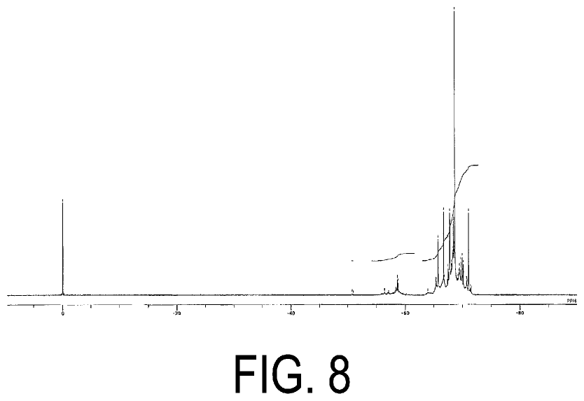

A ¹H-NMR chart of the resulting intermediate acrylic group-containing polyorganosilsesquioxane is illustrated in FIG. 7, and a ²⁹Si-NMR chart thereof is illustrated in FIG. 8.

### Example 4: Production of an Acrylic Group-Containing Polyorganosilsesquioxane According to an Embodiment of the Present Invention (1)

A mixture (71 g) containing the intermediate acrylic group-containing polyorganosilsesquioxane obtained in Production Example 2 was charged under a nitrogen stream into a 1000 mL flask (reaction vessel) equipped with a thermometer, a stirring device, a reflux condenser, and a nitrogen inlet tube. Next, 10 ppm (0.55 mg) of potassium hydroxide and 2000 ppm (110 mg) of water were added to a net content amount (55.0 g) of the intermediate acrylic group-containing polyorganosilsesquioxane, and the mixture was heated for 30 hours at 40° C., and then sampled, and the molecular weight was measured. It was found that the number average molecular weight Mn had increased to 5693. Next, the mixture was cooled to room temperature, 300 mL of methyl isobutyl ketone was added, and 300 mL of water was added, and when the alkali component was removed through repeated rinsing with water, and the mixture was concentrated, 71 g of a colorless, transparent, liquid product (acrylic-group containing polyorganosilsesquioxane according to an embodiment of the present invention) containing 25 wt. % of methyl isobutyl ketone was obtained.

When the product was analyzed, the number average molecular weight was found to be 5693, and the molecular weight dispersity was 2.58. A ratio of T2 forms and T3 forms [T3 forms/T2 forms] calculated from the ²⁹Si-NMR spectrum of the product was 47.3.

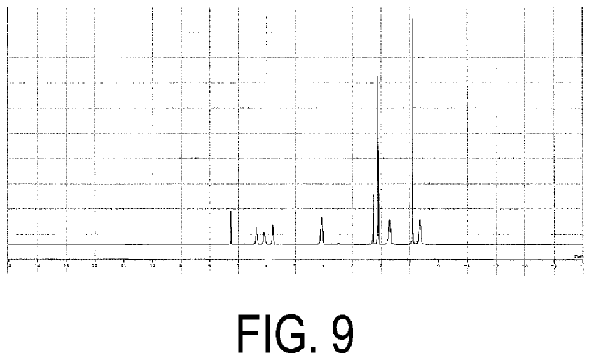

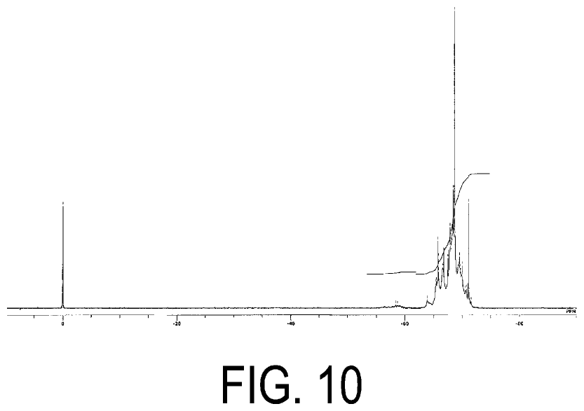

A ¹H-NMR chart of the resulting acrylic group-containing polyorganosilsesquioxane 1 is illustrated in FIG. 9, and a ²⁹Si-NMR chart thereof is illustrated in FIG. 10.

### Example 5: Production of a Transfer Film and a Molded Body

### Preparation of a Release Agent Coating Solution A

100 parts by weight of Nb/Et (2-norbornene-ethylene copolymer, “TOPAS (trade name) 6017S-04” available from Topas Advanced Polymers GmbH, glass transition temperature of 178° C.), and 1 part by weight of PVDC (polyvinylidene chloride) were added to a mixed solvent of toluene and tetrahydrofuran (toluene/tetrahydrofuran=70/30 (weight ratio)) so that the solid content concentration was 5 wt. %, and the mixture was heated and dissolved to prepare a release agent coating solution A.

### Fabrication of a Release Film A

A biaxially-stretched polyethylene terephthalate film (“Emblet S50”, available from Unitika Ltd., thickness of 50 μm) was used as the substrate layer, one side of this film was coated with the release agent coating solution A by the Mayer bar coating method and dried for 1 minute at a temperature of 100° C. to form a release layer with a thickness of 0.3 μm, and a release film A was obtained.

### Preparation of a Hard Coat Coating Solution A

100 parts by weight of the epoxy group-containing polyorganosilsesquioxane 3 (number average molecular weight Mn of 3500) obtained in Example 3, and 1.13 parts by weight of CPI-210S (photocationic polymerization initiator, available from San-Apro Co., Ltd.) were added to methyl isobutyl ketone so that the solid content concentration was 70 wt. %, and a hard coat coating solution A was prepared.

### Fabrication of a Transfer Film A

The hard coat coating solution A was coated onto the release layer surface of the release film A by the Mayer bar coating method, dried for 2 minutes at a temperature of 80° C., and then dried for 8 minutes at a temperature of 150° C. to form a hard coat layer having a thickness of 40 μm. When the surface of the obtained hard coat layer was touched with a finger, it was confirmed that the resin did not adhere to the finger, and surface tackiness was not exhibited (tack-free). K468HP anchor (epoxy resin-based anchor coating agent, available from Toyo Ink Co., Ltd.) was coated onto the hard coat layer using a Mayer bar coating method, dried for 30 seconds at a temperature of 80° C. to form an anchor coat layer having a thickness of 1 μm, and then a K588HP Adhesive Gloss A varnish (vinyl chloride-vinyl acetate copolymer resin-based adhesive available from Toyo Ink Co., Ltd.) was coated onto this anchor coat layer by the Mayer bar coating method and dried for 30 seconds at a temperature of 80° C. to form an adhesive agent layer with a thickness of 4 m, and a transfer film A was obtained.

### Fabrication of a Molded Body 1

The transfer film A was placed in a mold of the SE130DU-CI (all-electric, two-material injection molding machine available from Sumitomo Heavy Industries, Ltd.), and a transparent AB S (Toyolac, available from Toray Industries, Inc., grade 920-555) was injection molded at a mold temperature of 50° C. and a resin temperature of 230° C. to thereby obtain a molded article 1 having an uncured hard coat layer. The hard coat surface of the obtained molded body 1 having an uncured hard coat layer was irradiated with ultraviolet light from a high-pressure mercury lamp (available from Eye Graphics Co., Ltd.) for approximately 10 seconds (cumulative light dose of approximately 400 mJ/cm²), after which the hard coat surface was subjected to an annealing treatment at 60° C. for one week, and thereby a molded body 1 with a cured hard coat layer was obtained.

### Comparative Example 1: Production of a Transfer Film B and a Molded Body Fabrication of a Transfer Film B

A transfer film B was obtained with the same method as that used to obtain the transfer film A with the exception that the hard coat layer was formed by coating Seikabeam HT-S (a urethane acrylate-based hard coat agent available from Dainichiseika Color & Chemicals Mfg. Co., Ltd.) using the Mayer bar coating method and drying for 1 minute at a temperature of 100° C., and then subjecting to a UV curing treatment for approximately 2 seconds with ultraviolet light (cumulative light dose of approximately 30 mJ/cm²) from a high-pressure mercury lamp (available from Eye Graphics Co., Ltd.) to thereby form a semi-cured hard coat layer having a thickness of 4.5 μm.

### (Fabrication of a Molded Body 2)

A molded body 2 having a cured hard coat layer was obtained with the same method as that used to obtain the molded body 1 with the exception that the transfer film B was used in place of the transfer film A, and as the treatment after injection molding, irradiation with ultraviolet light from a high-pressure mercury lamp (available from Eye Graphics Co., Ltd.) for approximately 25 seconds (cumulative light dose of approximately 900 mJ/cm²) was performed to cure the semi-cured hard coat layer.

### Hardness Evaluation

The pencil hardness of the obtained molded bodies 1 and 2 was evaluated in accordance with the pencil hardness evaluation method stipulated in JIS-K-5600. The results obtained through this evaluation method are shown in Table 1.

TABLE 1

| Item | Example 5 | Comparative Example 1 |
|---|---|---|
| Molded body | 1 | 2 |
| Pencil hardness | 6H | HB |

Variations of embodiments of the present invention described above are additionally described below.

[1] A polyorganosilsesquioxane containing a constituent unit represented by Formula (1) below:

[Chem. 31]

[R¹SiO_{3/2}] (1)

[where R¹ represents a group containing a polymerizable functional group];

a constituent unit represented by Formula (I) below:

[Chem. 32]

[R^{a}SiO_{3/2}] (I)

[where R^{a} represents a group containing a polymerizable functional group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom],

a constituent unit represented by Formula (II) below:

[Chem. 33]

[R^{b}SiO_{2/2}(OR^{c})] (II)

[where R^{b} represents a group containing a polymerizable functional group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom; and R^{c} represents a hydrogen atom or an alkyl group having from 1 to 4 carbon atoms]; and

a constituent unit expressed by Formula (4) below:

[Chem. 34]

[RSiO_{2/2}(OR^{c})] (4)

[where R¹ is the same as in Formula (1). R^{c} is the same as in Formula (II)]; wherein

a molar ratio of the constituent unit represented by Formula (I) to the constituent unit represented by Formula (II), [(the constituent unit represented by Formula (I))/(the constituent unit represented by Formula (II))], is from 20 to 500,

a proportion of the constituent unit represented by Formula (1) and the constituent unit represented by Formula (4) is from 55 to 100 mol % relative to a total amount (100 mol %) of siloxane constituent units,

a number average molecular weight is from 2500 to 50000, and

a molecular weight dispersity (weight average molecular weight/number average molecular weight) is from 1.0 to 4.0.

[2] The polyorganosilsesquioxane according to [1], wherein the polymerizable functional group is a cationically polymerizable functional group or a radically polymerizable functional group.

[3] The polyorganosilsesquioxane according to [2], wherein the cationically polymerizable functional group is at least one type selected from the group consisting of an epoxy group, an oxetane group, a vinyl ether group, and a vinyl phenyl group (preferably an epoxy group).

[4] The polyorganosilsesquioxane according to [2], wherein the radically polymerizable functional group is at least one type selected from the group consisting of a (meth)acryloxy group, a (meth)acrylamide group, a vinyl group, and a vinylthio group (preferably a (meth)acryloxy group).

[5] The polyorganosilsesquioxane according to any one of [1] to [4], wherein the polymerizable functional group is an epoxy group or a (meth)acryloxy group.

[6] The polyorganosilsesquioxane according to any one of [1] to [5], wherein the polymerizable functional group is an epoxy group.

[7] The polyorganosilsesquioxane according to any one of [1] to [6], wherein the R¹ is:

a group represented by Formula (1a) below;

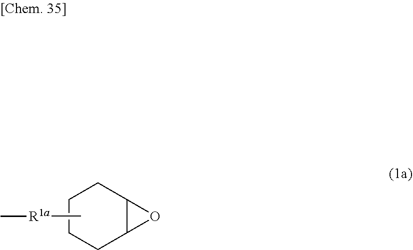

[where R^{1a} represents a linear or branched alkylene group (preferably an ethylene group or a trimethylene group, and more preferably an ethylene group)];

a group represented by Formula (1b) below,

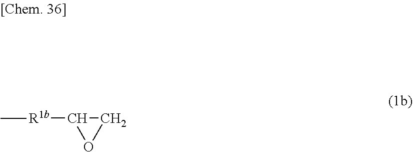

[where R^{1b} represents a linear or branched alkylene group (preferably an ethylene group or a trimethylene group, and more preferably a trimethylene group)];

a group represented by Formula (1c) below:

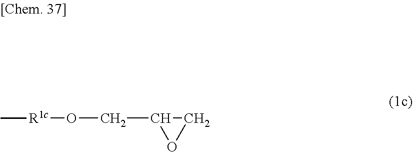

[where R^{1c} represents a linear or branched alkylene group (preferably an ethylene group or a trimethylene group, and more preferably a trimethylene group)]; or

a group represented by Formula (1d) below:

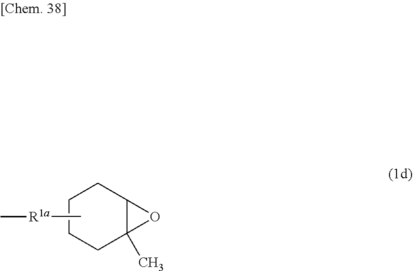

[where R^{1d} represents a linear or branched alkylene group (preferably an ethylene group or a trimethylene group, and more preferably an ethylene group)].

[8] The polyorganosilsesquioxane according to any one of [1] to [7], wherein the R¹ is a group containing a (meth)acryloxy group (preferably a 2-((meth)acryloxy) ethyl group or a 3-((meth)acryloxy) propyl group).

[9] The polyorganosilsesquioxane according to any one of [1] to [8], wherein the R¹ is a 2-(3′,4′-epoxycyclohexyl)ethyl group, a 3-(acryloxy)propyl group, or a 3-(methacryloxy)propyl group.

[10] The polyorganosilsesquioxane according to any one of [1] to [9], further containing a constituent unit expressed by Formula (2) below:

[Chem. 39]

[R²SiO_{3/2}] (2)

[where R² represents a substituted or unsubstituted aryl group, a substituted or unsubstituted aralkyl group, a substituted or unsubstituted cycloalkyl group, a substituted or unsubstituted alkyl group, or a substituted or unsubstituted alkenyl group].

[11] The polyorganosilsesquioxane according to [10], wherein the R² is a substituted or unsubstituted aryl group (preferably a phenyl group).

[12] The polyorganosilsesquioxane according to any one of [1] to [11], wherein a lower limit of the [T3 forms/T2 forms] ratio of the constituent unit (T3 body) represented by Formula (I) above to the constituent unit (T2 body) represented by Formula (II) above is 21 (preferably 23, and more preferably 25).

[13] The polyorganosilsesquioxane according to any one of [1] to [12], wherein the upper limit of the [T3 forms/T2 forms] ratio is 100 (preferably 50, and more preferably 40).

[14] The polyorganosilsesquioxane according to any one of [1] to [13], wherein the ratio (total amount) of constituent units represented by Formula (1) above and constituent units represented by Formula (4) above relative to a total amount (100 mol %) of siloxane constituent units is from 65 to 100 mol % (preferably, from 80 to 99 mol %).

[15] The polyorganosilsesquioxane according to any one of [1] to [14], wherein the ratio (total amount) of the constituent units represented by Formula (2) above and constituent units represented by Formula (5) above relative to a total amount (100 mol %) of siloxane constituent units is from 0 to 70 mol % (preferably from 0 to 60 mol %, more preferably from 0 to 40 mol %, and particularly preferably from 1 to 15 mol %).

[16] The polyorganosilsesquioxane according to any one of [1] to [15], wherein a ratio (total amount) of the constituent units represented by Formula (1) above, the constituent units represented by Formula (2) above, the constituent units represented by Formula (4) above, and the constituent units represented by Formula (5) above relative to a total amount (100 mol %) of siloxane constituent units is from 60 to 100 mol % (preferably from 70 to 100 mol %, and more preferably from 80 to 100 mol %).

[17] The polyorganosilsesquioxane according to any one of [1] to [16], wherein the number average molecular weight (Mn) is from 2800 to 10000 (preferably from 3000 to 8000).

[18] The polyorganosilsesquioxane according to any one of [1] to [17], wherein the molecular weight dispersity (Mw/Mn) is from 1.1 to 3.0 (preferably from 1.2 to 2.5).

[19] The polyorganosilsesquioxane according to any one of [1] to [18], wherein the 5% weight loss temperature (T_{d5}) in an air atmosphere is 330° C. or higher (for example, from 330 to 450° C., preferably 340° C. or higher, and more preferably 350° C. or higher).

[20] A curable composition containing a polyorganosilsesquioxane described in any one of [1] to [19].

[21] The curable composition according to [20], wherein a content amount (blended amount) of the polyorganosilsesquioxane is, per a total amount (100 wt. %) of the curable composition excluding the solvent, not less than 70 wt. % and less than 100 wt. % (preferably from 80 to 99.8 wt. %, and more preferably from 90 to 99.5 wt. %).

[22] The curable composition according to [20] or [21], wherein a ratio of the polyorganosilsesquioxane relative to a total amount (100 wt. %) of a cationically curable compound or a radically curable compound contained in the curable composition is from 70 to 100 wt. % (preferably from 75 to 98 wt. %, and more preferably from 80 to 95 wt. %).

[23] The curable composition according to any one of [20] to [22], further containing a curing catalyst.

[24] The curable composition according to [23], wherein the curing catalyst is a photocationic polymerization initiator.

[25] The curable composition according to [23], wherein the curing catalyst is a thermal cationic polymerization initiator.

[26] The curable composition according to [23], wherein the curing catalyst is a photoradical polymerization initiator.

[27] The curable composition according to [23], wherein the curing catalyst is a thermal radical polymerization initiator.

[28] The curable composition according to any one of [23] to [28], wherein a content amount (blended amount) of the curing catalyst relative to 100 parts by weight of the polyorganosilsesquioxane is from 0.01 to 3.0 parts by weight (preferably from 0.05 to 3.0 parts by weight, more preferably from 0.1 to 1.0 parts by weight, and even more preferably from 0.3 to 1.0 parts by weight).

[29] The curable composition according to any one of [20] to [28], further containing a vinyl ether compound.

[30] The curable composition according to any one of [20] to [29], further containing a vinyl ether compound having a hydroxyl group in the molecule.

[31] The curable composition according to [29] or [30], wherein a content amount (blending amount) of the vinyl ether compound (in particular, a vinyl ether compound having one or more hydroxyl groups per molecule) is, relative to a total amount (100%) of the cationically curable compound and the radically curable compound in the curable composition, from 0.01 to 10 wt. % (preferably from 0.05 to 9 wt. %, and more preferably from 1 to 8 wt. %).

[32] The curable composition according to any one of [20] to [31], the curable composition being a curable composition for forming a hard coat layer.

[33] A cured product of the curable composition described in any one of [20] to [32].

[34] A transfer film containing a substrate, and a hard coat layer laminated on a release layer formed on at least one surface of the substrate, wherein the hard coat layer contains the curable composition described in [32].

[35] The transfer film according to [34], wherein the substrate is a polyester film (particularly, polyethylene terephthalate, or polyethylene naphthalate), a cyclic polyolefin film, a polycarbonate film, a triacetyl cellulose film, or a polymethyl methacrylate film.

[36] The transfer film according to [34] or [35], wherein the thickness of the substrate is from 0.01 to 10000 μm (preferably from 2 to 250 μm, more preferably from 5 to 100 μm, and even more preferably 20 to 100 μm).

[37] The transfer film according to any one of [34] to [35], wherein a peel strength of the release layer and the hard coat layer is from 30 to 500 mN/24 mm (preferably from 40 to 300 mN/24 mm, and more preferably from 50 to 200 mN/24 mm).

[38] The transfer film according to any one of [34] to [37], wherein the component forming the release layer is at least one type selected from an unsaturated ester-based resin, an epoxy-based resin, an epoxy-melamine resin, an aminoalkyd resin, an acrylic resin, a melamine resin, a silicon-based resin, a fluororesin, a cellulose-based resin, a urea resin-based resin, a polyolefin resin, a paraffin resin, and a cycloolefin-based resin (preferably a cycloolefin resin, and particularly preferably a cycloolefin copolymer resin such as a 2-norbornene-ethylene copolymer).

[39] The transfer film according to any one of [34] to [38], wherein the thickness of the release layer is from 0.01 to 5 μm (preferably from 0.1 to 3.0 μm).

[40] The transfer film according to any one of [34] to [39], wherein the thickness of the hard coat layer is from 1 to 200 μm (preferably from 3 to 150 μm).

[41] The transfer film according to any one of [34] to [40], wherein a haze of the hard coat layer of a thickness of 50 μm is not greater than 1.5% (preferably not greater than 1.0%).

[42] The transfer film according to any one of [34] to [41], wherein the haze of the hard coat layer of a thickness of 50 μm is not less than 0.1%.

[43] The transfer film according to any one of [34] to [42], wherein a total light transmittance of the hard coat layer of a thickness of 50 μm is 85% or greater (preferably 90% or greater).

[44] The transfer film according to any one of [34] to [43], wherein the total light transmittance of the hard coat layer of a thickness of 50 μm is 99% or less.

[45] The transfer film according to any one of [34] to [44], wherein an anchor coat layer and an adhesive agent layer are further laminated in this order on the hard coat layer.

[46] The transfer film according to any one of [34] to [45], further containing at least one colored layer.

[47] The transfer film according to any one of [34] to [46], wherein the anchor coat layer is at least one type selected from the group consisting of a phenolic resin, an alkyd resin, a melamine resin, an epoxy resin, a urea resin, an unsaturated polyester resin, a urethane resin, a heat curing polyimide, a silicone resin, a vinyl chloride-vinyl acetate copolymer resin, an acrylic resin, a rubber chloride, a polyamide resin, a nitrocellulose resin, and a cyclic polyolefin-based resin (and preferably an epoxy resin).

[48] The transfer film according to any one of [34] to [47], wherein a thickness of the anchor coat layer is from 0.1 to 20 μm (preferably from 0.5 to m).

[49] The transfer film according to any one of [34] to [48], wherein the resin used in the adhesive agent layer is at least one type selected from the group consisting of an acrylic resin, a vinyl chloride resin, a vinyl acetate resin, a vinyl chloride-vinyl acetate copolymer resin, a styrene-acrylic copolymer resin, a polyester-based resin, and a polyamide resin (preferably an acrylic resin or a vinyl chloride-vinyl acetate copolymer resin).

[50] The transfer film according to any one of [34] to [49], wherein a thickness of the adhesive agent layer is from 0.1 to 10 μm (preferably from 0.5 to 5 μm).

[51] The transfer film according to any one of [34] to [50], wherein the thickness of the transfer film is from 1 to 10000 μm (preferably from 2 to 250 m, more preferably from 5 to 150 μm, and even more preferably from 25 to 150 μm).

[52] The transfer film according to any one of [34] to [51], wherein the film is a transfer film used for in-mold injection molding.

[53] An in-mold molded article to which a layer (transfer layer) is transferred, wherein the layer (the transfer layer) is obtained by removing the substrate on which the release layer is formed from the transfer film described in [52].

[54] A hard coat film having a substrate and a hard coat layer formed on at least one surface of the substrate, wherein the hard coat layer is a cured product layer of the curable composition described in [32].

[55] The hard coat film according to [54], wherein the substrate is a polyester film (particularly, polyethylene terephthalate, or polyethylene naphthalate), a cyclic polyolefin film, a polycarbonate film, a triacetyl cellulose film, or a polymethyl methacrylate film.

[56] The hard coat film according to [54] or [55], wherein the thickness of the substrate is from 0.01 to 10000 μm.

[57] The hard coat film according to any one of [54] to [56], wherein the thickness of the hard coat layer is from 1 to 200 μm (preferably from 3 to 150 μm).

[58] The hard coat film according to any one of [54] to [57], wherein a haze of the hard coat layer of a thickness of 50 μm is not greater than 1.5% (preferably not greater than 1.0%).

[59] The hard coat film according to any one of [54] to [58], wherein the haze of the hard coat layer of a thickness of 50 μm is not less than 0.1%.

[60] The hard coat film according to any one of [54] to [59], wherein a total light transmittance of the hard coat layer of a thickness of 50 μm is not less than 85% (preferably not less than 90%).

[61] The hard coat film according to any one of [54] to [60], wherein a total light transmittance of the hard coat layer of a thickness of 50 μm is 99% or less.

[62] The hard coat film according to any one of [54] to [61], wherein the hard coat film can be produced with a roll-to-roll process.

[63] The hard coat film according to any one of [54] to [62], further containing a surface protection film on the hard coat layer surface.

[64] The hard coat film according to any one of [54] to [63], wherein a thickness of the hard coat film is from 1 to 10000 μm.

[65] The hard coat film according to any one of [54] to [64], wherein a haze of the hard coat film is not greater than 1.5% (preferably not greater than 1.0%).

[66] The hard coat film according to any one of [54] to [65], wherein a haze of the hard coat film is not less than 0.1%.

[67] The hard coat film according to any one of [54] to [66], wherein the total light transmittance of the hard coat film is not less than 85% (preferably not less than 90%).

[68] The hard coat film according to any one of [54] to [67], wherein the total light transmittance of the hard coat film is not greater than 99%.

[65] A method for producing a hard coat film, the method including: (A) feeding out a substrate wound in a roll shape; (B) coating the curable composition described in [32] to at least one surface of the substrate that was fed out, and then curing the curable composition to form a hard coat layer; and subsequently (C) winding the obtained hard coat film onto a roll once again; wherein the steps (A) to (C) are performed sequentially.

### INDUSTRIAL APPLICABILITY

A molded article coated with a hard coat layer having a high surface hardness can be produced by performing in-mold injection molding using a transfer film having a hard coat layer containing a curable composition that contains the polyorganosilsesquioxane according to an embodiment of the present invention as an essential component. Furthermore, the uncured or semi-cured hard coat layer containing the polyorganosilsesquioxane according to an embodiment of the present invention is tack-free and can be wound into a roll shape and handled, and a transfer film containing the hard coat layer can be handled with a roll-to-roll process. Therefore, the curable composition according to an embodiment of the present invention can be preferably used as a curable composition for forming a hard coat layer of a hard coat film or a transfer film used for in-mold injection molding.

1. A polyorganosilsesquioxane comprising a constituent unit represented by Formula (1):
[R¹SiO_{3/2}] (1)
wherein R¹ represents a group containing a polymerizable functional group;
a constituent unit expressed by Formula (I):
[R^{a}SiO_{3/2}] (I)
wherein R^{a} represents a group containing a polymerizable functional group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom;
a constituent unit represented by Formula (II):
[RSiO_{2/2}(OR^{c})] (II)
wherein R^{b} represents a group containing a polymerizable functional group, a substituted or unsubstituted aryl group, a substituted or unsubstituted aralkyl group, a substituted or unsubstituted cycloalkyl group, a substituted or unsubstituted alkyl group, a substituted or unsubstituted alkenyl group, or a hydrogen atom; and R^{c} represents a hydrogen atom or an alkyl group having from 1 to 4 carbon atoms; and
a constituent unit expressed by Formula (4):
[R¹SiO_{2/2}(OR^{c})] (4)
wherein R¹ is the same as in Formula (1), R^{c} is the same as in Formula (II); wherein:
a molar ratio of the constituent unit represented by Formula (I) to the constituent unit represented by Formula (II), [(the constituent unit represented by Formula (I))/(the constituent unit represented by Formula (II))], is from 20 to 500,
a proportion of the constituent unit represented by Formula (1) and the constituent unit represented by Formula (4) is from 55 to 100 mol % relative to a total amount (100 mol %) of siloxane constituent units,
a number average molecular weight is from 2500 to 50000, and
a molecular weight dispersity, weight average molecular weight/number average molecular weight, is from 1.0 to 4.0.

2. The polyorganosilsesquioxane according to claim 1, further comprising a constituent unit expressed by Formula (2):
[R²SiO_{3/2}] (2)
wherein R² represents a substituted or unsubstituted aryl group, a substituted or unsubstituted aralkyl group, a substituted or unsubstituted cycloalkyl group, a substituted or unsubstituted alkyl group, or a substituted or unsubstituted alkenyl group.

3. The polyorganosilsesquioxane according to claim 2, wherein the R² is a substituted or unsubstituted aryl group.

4. The polyorganosilsesquioxane according to claim 1, wherein the polymerizable functional group is an epoxy group.

5. The polyorganosilsesquioxane according to claim 1, wherein the R¹ is:
a group represented by Formula (1a); 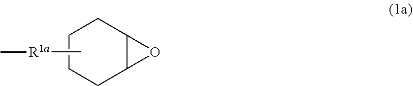
wherein R^{1a} represents a linear or branched alkylene group;
a group represented by Formula (1b), 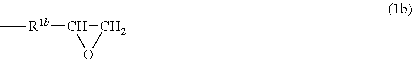
wherein R^{1b} represents a linear or branched alkylene group;
a group represented by the Formula (1c): 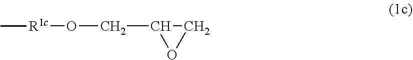
wherein R^{1c} represents a linear or branched alkylene group; or
a group represented by Formula (1d): 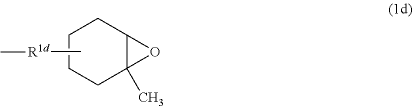
wherein R^{1d} represents a linear or branched alkylene group.

6. A curable composition comprising the polyorganosilsesquioxane according to claim 1.

7. The curable composition according to claim 6, further comprising a curing catalyst.

8. The curable composition according to claim 7, wherein the curing catalyst is a photocationic polymerization initiator.

9. The curable composition according to claim 7, wherein the curing catalyst is a thermal cationic polymerization initiator.

10. The curable composition according to claim 7, wherein the curing catalyst is a photoradical polymerization initiator.

11. The curable composition according to claim 7, wherein the curing catalyst is a thermal radical polymerization initiator.

12. The curable composition according to claim 6, further comprising a vinyl ether compound.

13. The curable composition according to claim 6, further comprising a vinyl ether compound having a hydroxyl group in the molecule.

14. The curable composition according to claim 6, the curable composition being a curable composition for forming a hard coat layer.

15. A cured product of the curable composition according to claim 6.

16. A transfer film comprising a substrate, and a hard coat layer laminated on a release layer formed on at least one surface of the substrate, the hard coat layer comprising the curable composition according to claim 14.

17. The transfer film according to claim 16, wherein an anchor coat layer and an adhesive agent layer are further laminated in this order on the hard coat layer.

18. The transfer film according to claim 16, further comprising at least one colored layer.

19. The transfer film according to claim 16, wherein a thickness of the hard coat layer is from 3 to 150 μm.

20. The transfer film according to claim 16, wherein the transfer film is used for in-mold injection molding.

21. An in-mold molded article to which a transfer layer is transferred, wherein the transfer layer is obtained by removing the substrate on which the release layer is formed from the transfer film according to claim 20.

22. A hard coat film comprising a substrate and a hard coat layer formed on at least one surface of the substrate, wherein the hard coat layer is a cured product layer of the curable composition according to claim 14.

23. The hard coat film according to claim 22, wherein a thickness of the hard coat layer is from 1 to 200 μm.

24. The hard coat film according to claim 22, wherein the hard coat film can be produced by a roll-to-roll process.

25. The hard coat film according to claim 22, further comprising a surface protection film on the hard coat layer surface.

26. A method for producing a hard coat film, the method comprising: (A) feeding out a substrate wound in a roll shape; (B) coating the curable composition according to claim 14 to at least one surface of the substrate that has been fed out, and then curing the curable composition to form a hard coat layer; and subsequently, (C) winding an obtained hard coat film onto a roll once again; wherein the steps (A) to (C) are performed sequentially.

27. A method for forming a hard coat layer, the method comprising using the curable composition according to claim 6.
